(19) United States
(12) Patent Application Publication
(10) Pub. No.: US 2019/0045826 A1
(43) Pub. Date: Feb. 14, 2019

(54) NUTRITIONAL FORMULATIONS SUCH AS A YOGHURT, CREAM, CREAM DESSERT OR FROZEN DESSERT, COMPRISING A PEA PROTEIN ISOLATE, AND THE USE OF THE FORMULATION AS A SOURCE OF PROTEIN

(71) Applicant: ROQUETTE FRERES, Lestrem (FR)

(72) Inventors: Manuel BARATA, Gonnehem (FR); Marilyne GUILLEMANT, Aire Sur La Lys (FR); Emmanuelle MORETTI, Lille (FR); Elsa MULLER, Béthune (FR); Marie DELEBARRE, La Couture (FR)

(21) Appl. No.: 16/079,891

(22) PCT Filed: Mar. 7, 2017
(86) PCT No.: PCT/FR2017/050496

§ 371 Date: Aug. 24, 2018

(30) Foreign Application Priority Data
Mar. 7, 2016 (FR) 1651865
Apr. 29, 2016 (FR) 1653861
Jul. 8, 2016 (FR) 1656605

(51) Int. Cl. A23L 33/185; A23L 33/19; A23J 3/14; A23J 3/34; A23L 11/30; A23L 2/395; A23L 2/66; A23L 9/20; A23L 11/00; A23L 9/10

(52) U.S. Cl. CPC A23L 33/185; A23L 33/19; A23J 3/14; A23J 3/34; A23L 11/30; A23C 9/13; A23L 2/66; A23L 9/24; A23L 11/05; A23L 9/12; A23L 2/395

(57) ABSTRACT

The present invention relates to a nutritional formulation of yoghurt type, a cream, a dessert cream, an iced dessert or sorbet and a cheese and containing a pea protein isolate, characterized in that the pea protein isolate:
contains between 0.5 and 2% of free amino acids,
has a viscosity:
   from 13 to 16×10⁻³ Pa·s. at a shear rate of 10 s⁻¹,
   from 10 to 14×10⁻³ Pa·s. at shear rate of 40 s⁻¹, and
   from 9.8 to 14×10⁻³ Pa·s. at a shear rate of 600 s⁻¹,
has a solubility:
   from 30 to 40% in pH zones from 4 to 5
   from 40 to 70% in pH zones from 6 to 8.

The invention also relates to the use of this nutritional formulation as a single protein source or as a food supplement, intended for infants, children and/or adults.

### TECHNICAL FIELD OF THE INVENTION

The present invention relates to nutritional formulations comprising a pea protein isolate.

More particularly, the invention relates to the application of these nutritional formulations:
as fermented milks of yoghurt type (stirred, Greek, drinking, etc. yoghurt),
as dairy/plant-based creams (such as coffee cream or “coffee whitener”), dessert creams, iced desserts or sorbets.

### CONTEXT OF THE INVENTION

In the context of the revegetation of market products and of cost reduction, it may be proposed to develop novel solutions based on pea protein as an alternative to milk protein.

To do this, the pea protein must satisfy certain functionalities such as good solubility, low viscosity in solution, good resistance to heat treatments for the heat-treated liquids, and also good viscosity stability over time.

It must also satisfy the nutritional recommendations recommended by the FAO/WHO, in terms of amino acid profile and digestibility profile.

Fermented Milks or Desserts Such as Stirred, Greek and Set Yoghurts

A yoghurt is a milk seeded with lactic acid ferments in order to thicken it and to conserve it for longer.

In order to be called a yoghurt, it must necessarily, and only, contain two specific ferments, Loctobacillus delbrueckii subsp. bulgaricus and Streptococcus thermophilus, which give it its taste specificity and its texture, and also provide certain nutritional and health benefits.

Other fermented milks (with a yoghurt texture) have been created in recent years. They may or may not contain these two bacteria, and in addition strains such as Lactobacillus acidophilus, Lactobacillus casei, Bifidobacterlum bifidum, B. longum, B. infantis and B. breve.

Yoghurts are thus an excellent source of probiotics, i.e. of live microorganisms, which, when ingested in sufficient amount, exert positive health effects, beyond the conventional nutritional effects.

Whether it is set, stirred or liquid, the name yoghurt is retained since, in point of fact, beyond the regulatory definitions, it is its manufacture which conditions its final texture.

Thus, to obtain a set yoghurt, the milk is seeded directly in the pot.

On the other hand, in the case of a stirred yoghurt (also called “bulgarian” yoghurt), the milk is seeded in a tank and then stirred, before being poured into its pot.

Finally, liquid yoghurt, also called drinking yoghurt, is stirred and then blended until the appropriate texture is obtained, and is poured into bottles.

However, other types of plain yoghurt also exist, such as Greek yoghurt, which has a thicker texture.

The percentage of fat may also modify the texture of the yoghurt, which may be manufactured based on whole milk, semi-skimmed milk or skimmed milk (a label comprising only the word “yoghurt” necessarily denotes a yoghurt made with semi-skimmed milk).

In all cases, its expiry date cannot exceed 30 days and it must always be stored in a refrigerator between 0° and 6°.

Three main classes of yoghurt are distinguished as follows:
Stirred yoghurt

More liquid, it is often more acidic than plain yoghurt. Only its texture differs. It is also known as bulgarian yoghurt—in reference to the supposed origins of yoghurt and to Lactobacillus bulgaricus, one of the two ferments involved in the transformation of milk into yoghurt. It is manufactured in a tank before being packaged in pots.

It is particularly suitable for making beverages, such as lassis, fruit cocktails, etc.
Greek yoghurt

This particularly thick yoghurt is a plain yoghurt that has been considerably strained (traditional technique) or enriched with cream. This very tasty, gourmet yoghurt is essential for the preparation of tsatsiki and for Eastern European dishes, and quite simply mixed with fines herbes, it is a delicious aperitif dip. Used cold, it can be used as a replacement for thick créme fraîche.
Drinking yoghurt

Although it exists in plain form, it is usually sweetened and flavored, and manufactured with a blended stirred yoghurt. Conceived of in 1974, it has enabled adolescents to rediscover the pleasure of milk, by eating yoghurt without a spoon, direct from the bottle. “Pouring yoghurt”, in a 950 g carton, has also recently come into existence, for those who wish to combine cereals and yoghurt for breakfast.

This low-energy—52 kcal for a fat-free yoghurt made from skimmed milk; 88 kcal for a whole-milk yoghurt—“plain” yoghurt is naturally low in fat and carbohydrates, but contains a fair amount of protein. It is also a source of micronutrients (especially calcium and phosphorus), as well as vitamins B2, B5, B12 and A. Yoghurt, which is constituted of 80% water, participates actively in hydrating the body.

Regular consumption of yoghurt is thus acknowledged to improve the digestion and absorption of lactose (EFSA opinion of Oct. 19, 2010). Other studies show potential benefits on improving diarrhea in children and on the immune system in certain persons such as the elderly.

However, the consumption of cow's milk is subject to increasing criticism and questioning, and an increasing number of people are quite simply deciding to cut it out of their diet, for example for reasons of lactose intolerance, or for allergenicity problems.

Plant-milk-based yoghurt solutions have thus been proposed, since plant milks are much easier to digest than cow's milk, and are rich in vitamins, minerals and unsaturated fatty acids.

In the rest of the present description, for the sake of simplicity, the term “yoghurt” will continue to be used, even if the origin of the protein is not dairy (officially, “yoghurts” that are manufactured from ingredients other than fermented milk, dairy ingredients or conventional ferments such as Lactobacillus delbrueckii subsp bulgaricus and Streptococcus thermophilus do not have the right to be named as such).

The plant source most commonly used is soybean. However, although soybean milk has the highest richness in calcium and protein, it is also very indigestible; this is why it is not recommended for children.

Furthermore, it is not recommended either to excessively consume soybean-based products since their effects on health may be counter-productive when they are consumed in large amount.

Moreover, it is commonly accepted that 70% of the worldwide production of soybean is from GMO sources.

Dairy Creams for Coffee Cream, Butter, Cheese, Chantilly Creams, Sauces, Cake Toppings and Decorations

Dairy creams are products containing more than 30% fat, obtained by concentrating milk, and are in the form of an emulsion of oil droplets in skimmed milk. They may be used for various applications, either directly as a consumer product (for example used as a coffee cream) or as an industrial raw material for the manufacture of other products such as butter, cheese, chantilly creams, sauces, ice creams, or alternatively cake toppings and decorations.

Various varieties of creams exist: créme fraîche, low-fat cream, single cream, double cream, pasteurized cream. Creams differ according to their fat content, their conservation and their texture.

Raw cream is cream obtained from the separation of milk and cream, directly after skimming and without performing a pasteurization step. It is liquid and contains from 30 to 40% fat.

Pasteurized cream, which is still of liquid texture, has undergone the pasteurization process. It has thus been heated at 72° C. for about 20 seconds so as to remove the microorganisms that are harmful to humans. This cream is particularly suitable for expanding. It thus takes on a lighter and more voluminous texture on being whipped to incorporate air bubbles therein. It is perfect for chantilly creams, for example.

Certain fluid creams sold in shops are termed as being “long-life”. They may be stored for several weeks in a cool, dry place. To be conserved for such a long time, these creams have either been sterilized, or heated via the UHT process. For sterilization, it is a matter of heating the cream for 15 to 20 minutes at 115° C. With the UHT (or Ultra-High Temperature) process, the cream is heated for 2 seconds at 150° C. The cream is then rapidly cooled, the result of which is that its taste qualities are better conserved.

Cream is naturally fluid, once it has been separated from milk, after skimming. In order for it to take a thick texture, it passes through the seeding step. Lactic acid ferments are thus incorporated and, after maturation, give the cream a thicker texture and a more acidic and richer taste.

Along with the conventional techniques (dating back millennia or centuries) for obtaining cream from milk, techniques for assembling or reconstituting cream from dairy ingredients have been developed in the last decade.

These novel techniques for reconstituting dairy creams have obvious advantages in industrial processes, compared with créme fraîche: low cost of storage of the raw materials, greater formulation flexibility, independence from the seasonal effect on the composition of the milk.

Thus, reconstituted dairy creams can benefit from the natural image generally attributed to dairy products, since the regulations stipulate for their manufacture the exclusive use of dairy ingredients with or without addition of drinking water and the same finished product characteristics as milk cream (Codex Alimentarius, 2007).

The development of the field of reconstituted dairy creams has opened up new possibilities in the formulation of creams, and more particularly that of the birth of the concept of plant-based creams.

Plant-based creams are products that are similar to dairy creams, the dairy fat of which is replaced with plant fat (Codex Alimentarius, codex Stan 192, 1995).

They are formulated starting with well-defined amounts of water, plant fat, dairy or plant protein, stabilizers, thickeners and emulsifiers of low molecular weight.

The physicochemical parameters, such as the particle size, the rheology, the stability and the expandability, are the characteristics which are of chief interest to manufacturers and researchers in the field of substitution of dairy creams with plant-based creams.

For example, as in any emulsion, the size of the dispersed droplets (particle size) is a key parameter in the characterization of creams since it has an appreciable impact firstly on the other physicochemical properties such as the rheology and the stability, and secondly on the sensory properties such as the texture and color of creams.

The influence of the type of emulsifier includes both low molecular weight emulsifiers such as monoglycerides, diglycerides and phospholipids, and high molecular weight emulsifiers such as proteins, and also protein/low molecular weight emulsifier interactions.

It is thus known that the concentration of the lipid emulsifier also has an influence on the droplet size of creams. In protein-stabilized systems, a very high concentration of the lipid emulsifier can cause a high increase in the mean droplet size, due to substantial aggregation of the droplets following desorption of the proteins.

The type of protein used in the formulation may also affect the particle size of creams. Specifically, under the same emulsification conditions, creams based on casein-rich protein sources, such as skimmed milk powder, generally have smaller mean droplet diameters than those based on whey protein-rich protein sources, such as whey powder.

The particle size differences between creams prepared from the two protein sources (caseins or whey proteins) are linked to the differences in interfacial properties at the oil/water interface, caseins having a higher capacity to lower the interfacial tension than whey proteins.

Moreover, the protein concentration in the formulation has an influence on the particle size of creams. Specifically, it has been demonstrated that, for a constant mass fraction of oil, the droplet size decreases as the protein concentration increases, up to a certain concentration beyond which the size varies very little.

The simultaneous presence of amphiphilic molecules of low molecular weight (surfactant) and high molecular weight (proteins) in a cream formulation is generally reflected by a decrease in the droplet size during emulsification. Moreover, competitive adsorption at the oil/water interface between surfactants and proteins generally leads during maturation to desorption of the proteins at the surface of the droplets, which may entail particle size changes.

Finally, it appears that the emulsification conditions, the choice of the ingredients (both proteins and lipids) used in the formulation, and the temperature, have an influence on the final properties of creams.

It appears that plant-based creams may lead to novel techno-functional properties. Thus, the resistance to freezing, which may impart great stability on ice creams, is an example thereof. They may also show cook-and-serve or cook-and-chill stability, which is a considerable advantage, since these creams may be used either in the preparation of hot or cold meals.

While plant-based creams may afford novel functionalities and show textural properties comparable to or even more interesting than those of dairy creams, it nevertheless remains that they may have sensory defects, especially with regard to their taste and their odor, even sometimes after the addition of flavorings (which is the case for soybean protein or pea protein).

The Applicant Company thus conducted studies on plant-based creams (including the field of “non-dairy” coffee creamers) so as to further the understanding regarding the influence of their ingredients, such as pea protein, and their interactions with each other (protein-protein, protein-fat, protein-water, etc.) on the final properties of the creams.

The Applicant Company also developed vegan cheese recipes.

Cheese is normally a food obtained from coagulated milk or from dairy cream, followed by straining and then optionally fermentation and optional maturing.

Cheese is thus manufactured mainly from cow's milk, but also from the milk of goats, sheep, buffaloes or other mammals. The milk is acidified, generally using a bacterial culture. An enzyme, rennet, or a substitute such as acetic acid or vinegar, is then added so as to bring about coagulation and to form clotted milk and whey.

It is known practice to prepare vegan alternatives to cheese (especially mozzarella-type cheeses) by replacing milk caseinates with native and modified starches, more particularly acetate-stabilized starches.

However, it is still sought to improve the shreddability or the capacity to be shredded, the melting, the stability to freezing/thawing and the taste (especially in the United States for pizza preparations).

Tests were conducted combining oil, modified starches and pea protein, but were not entirely satisfactory.

The Applicant Company found that the use of the pea protein isolates in accordance with the invention made it possible to satisfy these specifications, especially in terms of shreddability, melting and taste.

Ice Creams

Ice creams conventionally contain animal or plant fats, protein (milk protein, egg protein) and/or lactose.

The protein then acts as texturizer in addition to giving the ice cream taste.

They are essentially produced by weighing out the ingredients, premixing them, homogenizing, pasteurizing and refrigerating them at 4° C. (allowing maturation), followed by freezing before packaging and storing.

However, many people suffer from intolerance to dairy products or other ingredients of animal origin, which prevent them from consuming milk or conventional ice cream.

For this group of consumers, there has hitherto been no alternative to ice cream containing milk which has comparable sensory value.

In the ice cream preparations known hitherto containing plant ingredients, mainly based on soybean, attempts were made to replace the animal emulsifiers with plant proteins.

Dried plant proteins, obtained in conventional aqueous or aqueous-alcoholic extraction processes and in powder form after drying, were often used.

These proteins prove to be heterogeneous mixtures of polypeptides, certain fractions of which have variable degrees of particularly good properties such as emulsifiers or gel-forming agents, as water-binding agents, foaming agents or texture-improving agents.

Hitherto, plant protein products were obtained almost exclusively from soybean, without fractionation as a function of their specific functional properties.

Moreover, the taste of ice creams prepared with said soybean protein is offputting.

The Applicant Company thus conducted studies on plant-based creams and found that the pea protein isolates according to the invention made it possible to satisfy the desired specifications.

### SUMMARY OF THE INVENTION

The present invention proposes novel nutritional formulations of yoghurt, cream, dessert cream, cheese or ice cream type containing a pea protein isolate that can totally or partly substitute for milk or soybean protein, of neutral taste, and which have suitable properties such as a low viscosity and improvement of the solubility of the pea protein.

In particular, in the context of nutritional formulations of the fermented milk type or of yoghurt (stirred, Greek, drinking, etc. yoghurt) or dairy/plant-based cream (such as “coffee whitener”), iced dessert or sorbet type, the emulsifying capacity of said pea protein isolate is advantageous for its use in the matrices of these dairy products in partial or total replacement for dairy protein. In the context of vegan cheeses, the addition of said pea protein isolate makes it possible to improve the shreddability (the capacity to be shredded), the melting and the taste of mozzarella-type vegan cheeses.

The invention also leads to improving the taste of the pea protein (reducing the pea notes, green notes) in order to be more neutral in the applications/finished products (with a high content of protein and standard) using the pea protein isolate in partial or total substitution for milk protein, which is an important property for all types of dairy products, dairy or plant-based beverages, fermented milks of yoghurt type, dairy or plant-based creams, dessert cream, cheese or ice cream, etc.

The subject of the invention is, precisely, a nutritional formulation selected from a fermented milk of yoghurt type, a cream, a dessert cream, an iced dessert or sorbet and a cheese and comprising a pea protein isolate which:
contains between 0.5 and 2% of free amino acids,
has a viscosity at 20° C.:
   from 11 to 18×10⁻³ Pa·s. at a shear rate of 10 s⁻¹,
   from 9 to 16×10⁻³ Pa·s. at a shear rate of 40 s⁻¹, and
   from 8 to 16×10⁻³ Pa·s. at a shear rate of 600 s⁻¹,
has a solubility:
   from 30 to 40% in pH zones from 4 to 5
   from 40 to 70% in pH zones from 6 to 8.

Preferably, the pea protein isolate has a digestibility expressed according to the Coefficient of Digestive Use (CDU) of between 93.5 and 95%.

Preferably, the pea protein isolate has a degree of hydrolysis (DH) of between 5 and 10%.

In particular, the pea protein isolate is presented, according to the SYMPHID test, as a protein of “rapid viscosity”, reflecting rapid duodenal assimilation of the constituent amino acids of said isolate.

Preferably, the pea protein isolate has been pasteurized at high temperature for a short time before being dried by atomization.

In one embodiment of the present invention, the pea protein isolate represents 0.1-10% by weight of the nutritional formulation, preferably 0.5-6% by weight.

In one embodiment of the present invention, the pea protein isolate represents 20-30%, 40-50%, 50-60%, 60-70%, 70-80%, 80-90% or 90-100% by weight of the total protein in the nutritional formulation.

In one embodiment of the present invention, the nutritional formulation comprises at least one pea protein isolate and at least one milk protein. The milk protein preferably represents at least 10, 15, 20, 25, 30, 40, 45, 50, 60, 70 or 80% by weight relative to the total weight of proteins, in particular in the nutritional formulation in powder form.

In another embodiment of the present invention, the nutritional formulation comprises at least one pea protein isolate, another plant protein, such as a soybean, rice and/or wheat protein, and at least one milk protein.

The pea protein isolate represents:
between 0.1% and 100% of the total protein for fermented milks of yoghurt type, preferably between 20-100%, 30-100%, 40-100%, 50 and 100%, 60-100%, 70-100%, 80-100%, 20-60%, 30-50% or 50-90% of the total protein in the nutritional formulation,
between 0.1% and 100% of the total protein for dairy creams, iced desserts or sorbets, more particularly between 50-100%, 60-100%, 70-100%, 80-100%
50-90% of the total protein for coffee whiteners and
20-100%, 30-100%, 40-100%, 50-100%, or 40-90% of the total protein for dairy creams, iced desserts or sorbets.

For vegan cheeses, about 5% by weight of pea protein isolate in the recipe is sufficient to improve their technical and organoleptic characteristics.

For example, the pea protein isolate according to the present invention may represent 0.1-10%, 10-20%, 20-30%, 40-50%, 50-60%, 60-70%, 70-80%, 80-90% or 90-100%, in particular by weight, of the total protein in the nutritional formulation, or any combination of these percentage ranges.

A subject of the invention is also a nutritional formulation as described above, for use as a single protein source or as a food supplement, intended for infants, children and/or adults.

A subject of the invention is also the use of this nutritional formulation as a single protein source or as a food supplement, intended for infants, children and/or adults.

### DETAILED DESCRIPTION OF THE INVENTION

The present invention relates to nutritional formulations comprising a pea protein isolate according to the present invention. The invention also relates to the isolate according to the present invention, and in particular to the use of the isolate according to the present invention for the preparation of the nutritional formulations

More particularly, the invention relates to the application of these nutritional formulations as fermented milks of yoghurt type (stirred, Greek or drinking yoghurt) and as dairy or plant-based creams, dessert creams, iced desserts or sorbets or as cheeses.

It was found that the incorporation into said nutritional formula of the pea protein isolate of the invention makes it possible to improve the taste of the pea protein by reducing the pea note and the vegetable note.

All the percentages, parts and ratios, as used herein, relate to the weight of the total formulation, unless otherwise indicated.

The food formulations and the corresponding manufacturing processes of the present invention may comprise, consist of or essentially consist of the essential components of the invention as described herein, and also any additional or optional component described herein or otherwise useful in the applications of the nutritional formulation.

In the field of the (total or partial) replacement of dairy protein in yoghurts, dairy creams, ice creams or sorbets, plant protein whose functional properties are equivalent to or even better than those of dairy protein is sought.

In the present patent application, the term “functional properties” means any non-nutritional property which influences the usefulness of an ingredient in a dairy product.

These various properties contribute toward obtaining the desired final characteristics of the dairy product. Some of these functional properties are the solubility, the viscosity, the foaming properties and the emulsifying properties.

Protein also plays an important role in the sensory properties of the food matrices in which it is used, and there is a real synergy between the functional properties and the sensory properties.

The functional properties of protein, or functionalities, are therefore the physical or physicochemical properties which have an effect on the sensory qualities of the food systems generated during technological transformations, storage or domestic culinary preparations.

It is noted that, whatever the origin of the protein, said protein has an influence on the color, the flavor and/or the texture of a product. These organoleptic characteristics have a determining influence on the choice made by the consumer and they are, in this case, strongly taken into account by manufacturers.

The functionality of protein is the result of molecular interactions of the latter with its environment (other molecules, pH, temperature, etc.).

In this instance, it is a matter of the surface properties, which group together the properties of interaction of the protein with other polar or nonpolar structures in the liquid or gas phase: this covers the emulsifying, foaming, etc., properties.

The Applicant Company has noted that there is a real, unsatisfied, need for a nutritional formulation which has advantageous functional properties, and which can be used in dairy product preparation as an at least partial substitute for dairy protein.

By virtue in particular of their properties of taste improvement, pea protein isolates, as a source of protein, are particularly suitable for this use.

More particularly, in these particular fields of application, i.e.:
fermented milks of yoghurt type (stirred, Greek, drinking, etc. yoghurt),
dairy/plant-based creams (such as “coffee whitener”),
iced desserts or sorbets,

the Applicant Company has found that:
As regards “non-dairy coffee whiteners”, also known as “non-dairy coffee creamers”, as will be demonstrated hereinbelow:
   The viscosity of the emulsions after pasteurization before drying is closer to the milk control than pea protein of NUTRALYS® type, which makes it possible to dry a low-viscosity emulsion with a high solids content;
   The flocculation in coffee appears to be less pronounced with the pea protein isolates in accordance with the invention than with pea protein of NUTRALYS® type, but this may be correlated with the improvement of their solubility at the acidic pH of coffee, or by better stability to the divalent ions contained in the coffee reconstitution water.
   Moreover, optionally, to improve the flocculating power, it may be chosen to add buffers such as sodium citrates, salts of NaCl type (salt) which promotes protein solubility, or divalent-ion complexing agents that are more efficient than phosphate salts.
   As regards the emulsifying power of said isolates for this particular application, it may be advantageously chosen to use additional emulsifiers, for instance E472 (monoacetyltartaric and diacetyltartaric esters of fatty acid monoglycerides and diglycerides), or to vary the concentrations of E471, or by adjusting the protein concentration or adjusting the homogenization processes.
As regards “stirred yoghurts”, in the manufacturing recipes such as those that will be illustrated hereinbelow,
   The temperature before homogenization may range between 65 to 80° C.,
   The homogenization pressure may range between 150 to 250 bar,
   The pasteurization temperature may range between 80−85° C. for 30 minutes to 90-95° C. for 5 to 10 minutes,
   The fermentation temperature may range between 30 to 45° C., preferentially from 38 to 42° C.,
   It is possible to broaden the type of ferments to all those used in the yoghurt sector as specified in the “yoghurt” regulations.
As regards the formulation of said yoghurts:
   In addition to modified starch and pectin, as stabilizers, locust bean or guar gum in various proportions may be chosen,
   The starch selected is a modified starch, preferentially starch which develops little viscosity, or even is fully dissolved. Its proportion may range between 2.5 and 5% by weight of the total composition, preferably between 2.8 and 3.5%.
   It may be advantageously chosen to add milky flavorings, making it possible to provide a “more dairy” note or fruit preparations, even though the vegetable note is much more attenuated with the pea protein isolates according to the invention with regard to pea protein.
As regards “drinking yoghurts”, the recipes according to the invention are similar to those used for “stirred yoghurts”, but the amount of protein is much lower than that of stirred yoghurts, the amount of starch is preferentially chosen between 1.5% and 2.5% by weight of the total composition, and the starch may or may not be in a dissolved form for this matrix.

Nature of the Pea Protein Isolates

The pea protein isolates according to the invention are first characterized by their content of free amino acids (determined according to standard NF EN ISO13903:2005).

This value is between 0.5 and 2%. For example, this value may be between 0.5-1%, 1-1.5% or 1.5-2%, or any combination of these percentage ranges.

For comparative purposes, pea protein (such as NUTRALYS® S85F) has a content of free amino acids of about 0.18%.

The pea protein isolates have a total protein content expressed as N.6.25 of more than at least 70% by weight of dry product, preferably at least 80% by weight, for example between 80 and 99%, 80 and 95%, 80 and 90% or 80 and 85%.

The pea protein isolates according to the invention are also characterized by
their viscosity profile in water at 15% solids and at 20° C., determined as a function of the shear rate;
their solubility profile in water, as a function of the pH, preferably at 20° C.

For the determination of the viscosity profile in water, the measurements are taken
on an aqueous solution of pea protein isolates at 15% solids,
with an AR2000 rheometer from the company TA Instruments,
having concentric cylinder geometry,
with a shear rate of 0.6×10⁻³ at 600 s⁻¹ in 3 minutes (log) and
at a temperature of 20° C. (3 minutes of temperature equilibration before testing).

The shear rates produced in the rheometer make it possible to mimic the treatment conditions to which the solutions of pea protein isolate according to the invention may be subjected:
a shear rate from 1 to 10 s⁻¹ is thus characteristic of a beverage at rest (spoon texture for more viscous products),
a shear rate from 40 to 50 s⁻¹ is the texture in the mouth,
a shear rate of 300-1000 s⁻¹ is equivalent to the shear in product delivery pumps.

Thus, the pea protein isolates in accordance with the invention have a viscosity:
from 11 to 18×10⁻³ Pa·s. at a shear rate of 10 s⁻¹, preferably 12 to 17×10⁻³ Pa·s., even more preferably from 13 to 16×10⁻³ Pa·s.,
from 9 to 16×10⁻³ Pa·s. at a shear rate of 40 s⁻¹, preferably 10 to 15×10⁻³ Pa·s., even more preferably from 10 to 14×10⁻³ Pa·s., and
from 8 to 16×10⁻³ Pa·s. at a shear rate of 600 s⁻¹, preferably 9 to 15×10⁻³ Pa·s., even more preferably from 9.8 to 14×10⁻³ Pa·s.

This reflects noteworthy stability of said isolates, irrespective the shear force to which they are subjected.

The pea protein isolates are then characterized by their water solubility profile, as a function of the pH.

The principle of the method used is as follows, as will be developed in the example section:
suspend the pea protein isolate at 2.5% by weight in distilled water,
adjust to the desired pH: in this case 3, 4, 5, 6, 7 or 8 with 0.1 N NaOH or 0.1 N HCl,
mix for 30 minutes at 1100 rpm,
centrifuge for 15 minutes at 3000 g,
measure the solids content of a portion of the supernatant.

The solubility of the pea protein isolates is thus:
from 30 to 40% in pH zones from 4 to 5,
from 40 to 70% in pH zones from 6 to 8,

which reflects their noteworthy solubility within these pH zones.

For comparative purposes, pea protein (such as NUTRALYS® S85F) has:
from 10 to 15% solubility in pH zones from 4 to 5,
from 20 to 50% solubility in pH zones from 6 to 8.

The pea protein isolates are also characterized by their total digestibility profile, with regard to an intact pea protein, and by their digestion kinetics.

As will be illustrated hereinbelow, the digestibility measured in vivo makes it possible to attribute to the pea protein isolates according to the invention a Coefficient of Digestive Use (CDU) with a value of between 93.5 and 95%.

To measure the digestion kinetics of the pea protein isolates, an in vitro model of dynamic digestion under physiological conditions equivalent to the stomach and then the small intestine is used (see example 1, section 4).

As will be illustrated hereinbelow, the behavior of the isolates according to the invention in such a model shows their original positioning between intact pea protein (digestion of “rapid intermediate” type) and whey protein (digestion of “rapid” type).

The pea protein isolates are finally characterized in an in vitro digestibility model as “rapid-digestibility protein”.

To obtain this result, the gastric behavior of five proteins (pea protein, whey protein and sodium caseinates, and two batches of pea protein isolates according to the invention) is evaluated in an in vitro digestion model (see example 1, section 5).

The digestion kinetics of the proteins depend to a large extent on the residence time in the stomach and on the gastric emptying time.

The viscosity is an important characteristic determining the gastric emptying rate. Thus, in vitro viscosity measurements under gastric conditions are selected as pertinent parameters for characterizing the proteins.

The protein preparations are introduced into an in vitro system which simulates gastrointestinal digestion, in the present case the system developed by the company NIZO (SIMPHYD system, meaning SIMulation of PHYsiological Digestion) as presented on the website www.nizo.com in their brochure entitled Bioavailabilty of your ingredients which makes reference to the article published in Appl. Environ. Microbiol. 2007, January; 73(2): 508-15.

This device presents a system of online rheological measurements for comparing the behavior of the test proteins.

The viscosity profiles over time are measured under gastric pH and enzyme release conditions.

As illustrated hereinbelow, when compared with whey protein (classified in the “low viscosity” category) and sodium caseinates (classified among the “prolonged high viscosity” proteins):
pea protein shows a rapid increase in viscosity during acidification, which returns to the baseline at pH 2 (“rapid intermediate viscosity” proteins), whereas
the pea protein isolates according to the invention show a very slight increase in viscosity after acidification, which then decreases to reach values similar to those of whey protein, over 30 minutes (“rapid viscosity” proteins).

Based on their in vitro gastric behavior, the pea protein isolates according to the invention are thus rapidly transported into the duodenum, which will result in rapid assimilation of their amino acids.

Evaluation of the emulsifying properties of the pea protein isolates is performed in comparison with pea protein and milk protein.

It was performed using a Malvern Mastersizer 2000E particle size analyzer via the liquid route.

The measurement principle is based on light scattering.

The powders are dissolved at 1% by weight in azide-containing water with stirring for 6 hours at 750 rpm.

4 ml of edible oil combining four plant oils (sunflower, rapeseed, “oléisol” hybrid sunflower, grapeseed) (for example the oil Lesieur Isio 4) are added to 20 ml of proteins (or protein isolate) at 1%.

The whole is blended in a homogenizer (Ultra-Turrax) for 3 minutes at 13 500 rpm, and the emulsions thus formed are then analyzed with a particle size analyzer so as to determine the size of the fat globules thereof.

As will be illustrated hereinbelow, the pea protein isolates according to the invention have better emulsifying properties than the milk protein.

Moreover, their emulsifying property equivalent to that of caseinates makes them most particularly advantageous for the preparation of dried emulsions of “coffee whitener” type.

The present invention relates to the pea protein isolate as described above and to the use thereof for preparing a nutritional formulation.

Preparation of the Pea Protein Isolates According to the Invention

The preparation of the pea protein isolates according to the invention comprises enzymatic or non-enzymatic hydrolysis of the pea protein, so that said pea protein isolate has a degree of hydrolysis (DH) of between 5% and 10%, preferably between 6% and 8% and even more specifically from 6.5% to 7%.

In a first embodiment, the hydrolysis is performed with an endopeptidase.

A nonspecific endopeptidase is chosen, derived from a strain of Aspergillus, in particular a strain of Aspergillus spp or Aspergillus oryzae.

An endopeptidase EC 3-4-11 is more particularly chosen.

The exact amount of enzyme added to the suspension to obtain the desired characteristics of the pea protein isolates will vary as a function of specific characteristics such as:

(1) the enzyme or the enzymatic system used:

(2) the desired final degree of hydrolysis; and/or

(3) the desired molecular weight/final distribution.

Given that these parameters are known, a person skilled in the art can readily determine the appropriate conditions for obtaining the desired characteristics of the pea protein isolate.

In one particular embodiment, the initial pea protein used to prepare the pea protein isolate according to the invention is a pea protein composition as described in patent application WO 2007/17572 or prepared via a process as described in patent application WO 2007/17572 (the teaching being incorporated by reference). In one particular embodiment, the initial pea protein composition is the composition sold by Roquette Frères under the brand name NUTRALYS® S85F.

In a preferred embodiment of the invention, the pea protein suspension is brought to a value of 5 to 20% by weight of solids, in particular from 15 to 20%.

The reaction temperature is adjusted to a value of between 50 and 60° C., preferably about 55° C.

As a general rule, the enzyme system or an enzyme is added to the suspension in amounts in the range from about 0.3 to 1% weight/volume.

The hydrolysis reaction is typically performed over a desired time so as to obtain the desired degree of hydrolysis and/or desired molecular weight profile, in the present case for a time from about 45 minutes to about 2 hours 30 minutes, preferably about 1 hour.

Once again, the time required for the hydrolysis reaction depends on the characteristics as indicated above, but may be readily determined by a person skilled in the art.

In other embodiments, the suspension containing pea protein may be hydrolysed using non-enzymatic means, for example by mechanical (physical) and/or chemical hydrolysis. This technique is also well known in the prior art.

Once the pea protein has been hydrolyzed to the desired degree, the hydrolysis reaction is stopped, for example by inactivating the enzyme, or via other standard means.

In one embodiment, the inactivation of the enzyme is performed by heat treatment.

In accordance with the established practice, the enzyme preparation may be suitably inactivated by increasing the temperature of the incubation suspension to a temperature at which the enzymes become inactivated, for example to about 70° C. for about 10 minutes.

The pea protein isolates thus obtained are then treated at high temperature for a short time (HTST) and then pasteurized and optionally concentrated to a solids content from 10 to 30%, before being dried by atomization. For example, the isolate may be pasteurized at a temperature of between 130° C. and 150° C. for a time from about 1 second to about 30 seconds.

The present invention thus relates to a pea protein isolate that is obtained or that may be obtained via the process as described above.

The present invention also relates to a nutritional formulation comprising a pea protein isolate according to the invention and also to the use of this isolate for preparing a nutritional formulation.

The nutritional formulation may comprise between 20 and 95% of protein relative to the total weight of the nutritional formulation, for example between 20-90%, 30-80% or 40-60%.

The pea protein isolates according to the invention are present in the nutritional formulation according to the invention in an amount ranging up to 100% by weight, especially in an amount of between 52 and 60% by weight, in particular of the nutritional formulation. For example, the pea protein isolate according to the present invention may represent 10-20%, 20-30%, 40-50%, 50-60%, 60-70%, 70-80%, 80-90% or 90-100% of the total protein of the nutritional formulation, or any combination of these percentage ranges. For example, the pea protein isolate according to the present invention may represent 40-50%, 50-60%, 60-70%, 70-80%, 80-90% or 90-100% of the total protein of the formulation, or any combination of these percentage ranges.

Moreover, the pea protein isolate according to the present invention may represent 0.1-10%, 10-20%, 20-30%, 40-50%, 50-60%, 60-70%, 70-80%, 80-90% or 90-100% by weight of the nutritional formulation, or any combination of these percentage ranges. Preferably, it represents 0.1-60%, 1-50%, 1-20% or 1-10% or any combination of these percentage ranges. Preferably, the pea protein isolate represents 0.1-10% by weight of the nutritional formulation, preferably 0.5-6% by weight.

In a particular embodiment, the nutritional formulation in powder form comprises a combination of a pea protein isolate and of a milk-based protein.

In one example of this particular embodiment, the milk-based protein is present in the nutritional formulation in an amount of at least 10, 15, 20, 25, 30, 40, 45, 50, 60, 70 or 80% by weight relative to the total weight of protein, preferably from about 50 to 75% by weight relative to the total weight of protein, for example 45% by weight relative to the total weight of protein. For example, the milk-based protein is present in the nutritional formulation in powder form in an amount of 10-60%, 20-50%, 30-40% or 50-75% by weight relative to the total weight of protein. Preferably, the rest of the protein is provided by the pea protein isolate according to the invention.

In another example of this particular embodiment, the milk-based protein is present in the nutritional formulation in liquid form for clinical nutrition in an amount of at least 10, 15, 20, 25, 30, 40, 45 or 50% by weight relative to the total weight of protein, preferably about 50% by weight. For example, the milk-based protein is present in the nutritional formulation in liquid form for clinical nutrition in an amount of 10-60%, 20-50%, 30-40% or 45-55% by weight relative to the total weight of protein. Preferably, the rest of the protein is provided by the pea protein isolate according to the invention.

In another example of this particular embodiment, the milk-based protein is present in the nutritional formulation in liquid form for sport in an amount of at least 10, 15, 20, 25, 30, 40, 50, 60 or 75% by weight relative to the total weight of protein, preferably about 75% by weight. For example, the milk-based protein is present in the nutritional formulation in liquid form for sport in an amount of 10-60%, 20-50%, 30-40% or 45-55% by weight relative to the total weight of protein. Preferably, the rest of the protein is provided by the pea protein isolate according to the invention.

Nature of the Other Ingredients

The nutritional formulations in powder form may comprise at least one fat, one protein or one carbohydrate, in which at least some of the protein is a pea protein isolate.

The liquid nutritional formulations may comprise at least one protein, carbohydrate and fat, in which at least some of the protein is a pea protein isolate.

In general, a source of fat, carbohydrate and protein, in addition to the pea protein isolate, may be used here, on condition that these macronutrients are also compatible with the essential components of the nutritional formulations according to the invention.

Although the total concentrations or the amounts of fat, protein and carbohydrate may vary according to the users nutritional needs, these concentrations or amounts usually fall within one of the following ranges, including any other essential fat, protein, carbohydrate and/or ingredients as described herein:
for the dairy products (in the form of yoghurts, dairy beverages, dairy creams, iced desserts or sorbets),
   the fat concentrations are from about 0% to about 15%, preferentially from about 1.5% to about 10%, even more preferentially from about 3% to about 6% by weight of the nutritional formulation in liquid form;
   the protein concentrations are from about 1% to about 25%, preferentially from about 2% to about 20%, even more preferentially from about 2.5% to about 15% by weight of the nutritional formulation in liquid form;
   the carbohydrate concentrations are from about 5% to about 45%, preferentially from about 9% to about 25%, even more preferentially from about 13% to about 20% by weight of the nutritional formulation in liquid form.

Nonlimiting examples of fats (in powder or liquid form) or suitable sources thereof for use in the food formulations in powder and liquid form described herein comprise coconut oil, fractionated coconut oil, soybean oil, corn oil, olive oil, safflower oil, safflower oil rich in oleic acid, sunflower oil, sunflower oil rich in oleic acid, palm and palm kernel oils, palm olein, canola oil, marine oils, cotton oils, fats of dairy origin, and combinations thereof.

Nonlimiting examples of carbohydrates or of suitable sources thereof for use in the food formulations in powder and liquid form described herein may comprise maltodextrins, dextrins, corn starch or hydrolyzed or modified corn starch, glucose polymers, corn syrup, carbohydrates derived from rice, glucose, fructose, lactose, high-fructose syrup, honey, sugar alcohols (for example maltitol, erythritol or sorbitol), and combinations thereof.

Nonlimiting examples of proteins, including pea protein isolates, for use in the food formulations in powder and liquid form comprise hydrolyzed, partially hydrolyzed or non-hydrolyzed proteins or protein sources, which may be derived from any known source, such as milk (for example casein or whey), from animals (for example meat or fish), from cereals (for example rice or corn), from oleaginous plants (soybean or rapeseed), seed-bearing leguminous plants (lentils, chickpeas or beans), or combinations thereof.

Nonlimiting examples of such proteins comprise milk protein isolates, milk protein concentrates such as whey protein concentrates, casein, whey protein isolates, caseinates, whole cow's milk, skimmed milk, soybean protein, partially or totally hydrolyzed protein isolates, concentrated soybean protein, and the like.

Nature of the Optional Ingredients

The nutritional formulations according to the invention may also comprise other ingredients that can modify the chemical, physical, hedonic or processing characteristics of the products or serve as pharmaceutical or additional nutritional components when they are used by certain target populations.

Many of these optional ingredients are known or otherwise adapted for use in other food products and may also be used in the nutritional formulations in accordance with the invention, on condition that these optional ingredients are safe and efficient for oral administration and are compatible with the other essential ingredients of the selected product.

Nonlimiting examples of such optional ingredients comprise preserving agents, antioxidants, emulsifiers, buffers, pharmaceutical active agents, additional nutrients, dyes, flavorings, thickeners and stabilizers, etc.

The nutritional formulations in powder or liquid form may also comprise vitamins or associated nutrients, such as vitamin A, vitamin E, vitamin K, thiamine, riboflavin, pyridoxine, vitamin B12, carotenoids, niacin, folic acid, pantothenic acid, biotin, vitamin C, choline, inositol, salts thereof and derivatives thereof, and combinations thereof.

The nutritional formulations in powder or liquid form may also comprise minerals, such as phosphorus, magnesium, iron, zinc, manganese, copper, sodium, potassium, molybdenum, chromium, selenium, chloride, and combinations thereof.

The nutritional formulations in powder or liquid form may also comprise one or more masking agents to reduce, for example, the bitter tastes in reconstituted powders.

Suitable masking agents comprise natural and artificial sweeteners, sources of sodium, such as sodium chloride, and hydrocolloids such as guar gum, xanthan gum, carrageenan, and combinations thereof.

The amount of masking agent in the nutritional formulation in powder form may vary as a function of the particular masking agent selected, the other ingredients of the formulation and other formulation variables or target products.

The term “about” means the value plus or minus 10%, preferably plus or minus 5%.

### DESCRIPTION OF THE FIGURES

FIG. 1: Analysis of the digestibility by monitoring the viscosities using the SIMPHYD device from NIZO

FIG. 2: Solubility profile of the pea protein isolates as a function of the pH

FIG. 3: Monitoring of the viscosity during the in vitro digestion of the pea protein isolates according to the invention

FIG. 4: Sensory analysis of dessert creams for clinical nutrition

FIG. 5: Size distribution of the fat globules of the emulsion prepared with 100% milk protein for an iced dessert preparation

FIG. 6: Size distribution of the fat globules of the emulsion prepared with 50% milk protein and 50% pea protein NUTRALYS® S85F for an iced dessert preparation

FIG. 7: Size distribution of the fat globules of the emulsion prepared with 50% milk protein and 50% pea protein isolate No. 1 according to the invention for an iced dessert preparation

FIG. 8: Size distribution of the fat globules of the emulsion prepared with 50% milk protein and 50% pea protein isolate No. 2 according to the invention for an iced dessert preparation

FIG. 9: melting profile of vegan ice creams prepared with the pea protein isolates according to the invention

FIG. 10: Sensory analysis of iced desserts

FIG. 11: solubility of the pea protein isolates as a function of the pH in comparison with sodium caseinates

FIG. 12: Sensory analysis of stirred yoghurts—Taste Aspects

FIG. 13: Sensory analysis of stirred yoghurts—Texture Aspects

FIG. 14: Sensory analysis of vanilla-flavoured dessert creams

The invention will be understood more clearly with the aid of the following examples which are intended to be illustrative and nonlimiting.

### EXAMPLES

Materials and Methods

Measurement of the DH (Degree of Hydrolysis)

This measurement is based on the method for determining the amino nitrogen on proteins and protein isolates according to the invention with the MEGAZYME kit (reference K-PANOPA) and calculation of the degree of hydrolysis.

Principle:

The “amino nitrogen” groups of the free amino acids of the sample react with N-acetyl-L-cysteine and o-phthalyldialdehyde (OPA) to form isoindole derivatives.

The amount of isoindole derivative formed during this reaction is stoichiometric with the amount of free amino nitrogen. It is the isoindole derivative that is measured by the increase in absorbance at 340 nm.

Procedure:

Introduce an accurately weighed test sample P* of the sample to be analyzed into a 100 ml beaker. (This test sample will be from 0.5 to 5.0 g as a function of the amino nitrogen content of the sample.)

Add about 50 ml of distilled water, homogenize and transfer into a 100 ml measuring cylinder, add 5 ml of 20% SDS and make up to the volume with distilled water; stir for 15 minutes on a magnetic stirrer at 1000 rpm.

Dissolve 1 tablet of flask 1 of the Megazyme kit in 3 ml of distilled water and stir until fully dissolved. Provide one tablet per test.

This solution No. 1 is to be prepared extemporaneously.

The reaction takes place directly in the spectrophotometer cuvettes.
Blank:
Introduce 3.00 ml of solution No. 1 and 50 μl of distilled water.
Standard:
Introduce 3.00 ml of solution No. 1 and 50 μl of flask 3 of the Megazyme kit.
Sample:

Introduce 3.00 ml of solution No. 1 and 50 μl of the sample preparation.

Mix the cuvettes and read the absorbance measurements (A1) for the solutions after about 2 minutes on the spectrophotometer at 340 nm (spectrophotometer equipped with cuvettes with a 1.0 cm optical path, which can measure at a wavelength of 340 nm, and verified according to the procedure described in the manufacturer's technical manual related thereto).

Start the reactions immediately by adding 100 μl of the OPA solution flask 2 of the Megazyme kit to the spectrophotometer cuvettes.

Mix the cuvettes and place them in darkness for about 20 minutes.

Next, read the absorbance measurements for the blank, the standard and the samples on the spectrophotometer at 340 nm.

Calculation Method:

The content of free amino nitrogen, expressed as a mass percentage of product per se, is given by the following formula:

$$\begin{matrix}[ {NH}_{2} \% crude ] = \frac{( Δ A sample - Δ A blank ) \times 3.15 \times 14.01 \times V \times 100}{6803 \times 0.05 \times 1000 \times m} \\ = \frac{( Δ A sample - Δ A blank ) \times 12.974 \times V}{m \times 1000}\end{matrix}$$

in which: ΔA=A2−A1

V=volume of the flask

m=mass of the test sample in g

6803=extinction coefficient of the isoindole derivative at 340 nm (in L·mol⁻¹·cm⁻¹).

14.01=molar mass of nitrogen (in g·mol⁻¹)

3.15=final volume in the cuvette (in ml)

0.05=test sample in the cuvette (in ml)

The degree of hydrolysis (DH) is given by the formula:

$$DH = \frac{Protein nitrogen ( \% )}{Amino nitrogen ( \% ) \times 100}$$

in which the protein nitrogen is determined according to the DUMAS method according to standard ISO 16634.

Measurement of the Solubility in Water at Various pH Values

This measurement is based on diluting the sample in distilled water, centrifuging it and analyzing the supernatant.

Procedure:

Introduce 150 g of distilled water at a temperature of 20° C.±2° C. into a 400 ml beaker, mix with a magnetic bar and add precisely 5 g of the test sample.

Adjust the pH, if necessary, to the desired value with 0.1 N NaOH.

Make up the content with water to 200 g.

Mix for 30 minutes at 1000 rpm and centrifuge for 15 minutes at 3000 g.

Collect 25 g of the supernatant.

Introduce into a predried and tared crystallizing dish.

Place in an oven at 103° C.±2° C. for 1 hour.

Next, place in a desiccator (with dehydrating agent) to cool to room temperature, and weigh.

The content of soluble solids, expressed as a weight percentage, is given by the following formula:

$$\frac{( m 1 - m 2 ) \times ( 200 + P ) \times 100}{P 1 \times P} = \% solubility$$

in which:
P=weight, in g, of the sample=5 g
m1=weight, in g, of the crystallizing dish after drying
m2=weight, in g, of the empty crystallizing dish
P1=weight, in g, of the sample collected=25 g

Measurement of the In Vitro Digestibility

The SIMPHYD device from NIZO is a static model of simulation of the digestion processes along the gastrointestinal tract.

Gastric digestion is combined with an online viscosity measurement over time. Adapted to physiological conditions, gastric acidification is initiated with concentrated HCl and the enzymes of enzymatic digestion (pepsin and lipase) are added.

All the samples are subjected to the SIMPHYD device at a concentration of 3% (m/v).

The measurements are taken as follows:
A viscosity baseline is determined over 5 minutes, at natural pH and at 37° C.
Acidification to pH 2 is then performed with HCl and the system is maintained at 37° C. for 15 minutes,
Pepsin and lipase are added at 20 minutes.

The viscosity is monitored for 3 hours, using an AR-2000 TA Instruments rheometer at a shear rate of 75 s⁻¹.

The measurements are taken in duplicate. If the difference between two measurements is too large, a third measurement is taken.

The profile of the test proteins is compared with those established by Hall et al. (2003 article entitled Casein and whey exert different effects on plasma amino acid profiles, gastrointestinal hormone secretion and appetite published in Br. J. Nutr. 89: 239-248) for “rapid” and “slow” proteins (whey protein and sodium caseinates, respectively).

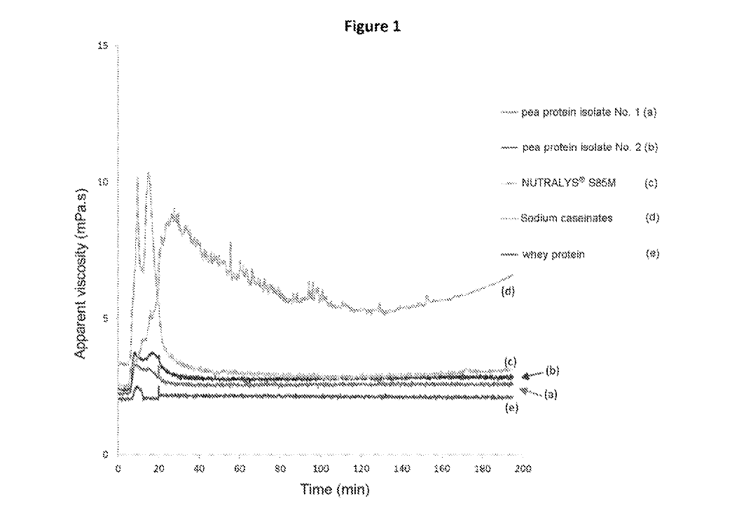

The viscosity profiles obtained are presented in FIG. 1.

The apparent viscosity of the control whey protein sample does not change during the gastric process, whereas the apparent viscosity of the sodium caseinate control increases after gastric acidification and remains high after addition of the digestive enzymes.

After 5 minutes of acidification, the pea protein (NUTRALYS® S85M) shows a first viscosity peak, followed by a second at 15 minutes, and the viscosity profile then rejoins that of the whey protein, at slightly higher values.

The viscosity begins to fall before the addition of the digestive enzymes.

The pea protein isolates according to the invention show a very small increase in apparent viscosity, which decreases again to values slightly above those of the whey protein, for 30 minutes.

The behavior of the pea protein isolates according to the invention reflects their “rapid” nature characteristic of protein that is more satiety-generating than “slow” protein. This induces faster gastric emptying and a post-absorptive increase in plasmatic amino acids.

Measurement of the Emulsifying Power

As indicated above, the measurements are taken by light scattering of redissolved protein powder, the emulsions obtained being analyzed with a particle size analyzer for the size of the fat globules formed.

The results are expressed by:
The Dmode, diameter of the main population,
The D(4.3), arithmetic mean diameter
The D10, D50 and D90, diameters for which there is 10%, 50% and 90% of passage.

The table below collates the size of the fat globules of the emulsions prepared using:
the two pea protein isolates in accordance with the invention, No. 1 and No. 2,
various milk proteins
a batch of sodium caseinates.

The ΔD corresponds to the difference between the D90 and the D10; it reflects the state of dispersion of the emulsions.

The smaller this value, the closer the droplet sizes, and the more homogeneous the emulsion.

| | Emulsifying capacity: emulsion | | | | | Emulsion |
|---|---|---|---|---|---|---|
| | size (Dmode in μm) | | | | | stability |
| | Dmode | D(4.3) | D10 | D50 | D90 | (ΔD) |
| pea protein isolate | 23.4 | 20.5 | 2.1 | 19.4 | 38.4 | 36.3 |
| No. 1 according to | | | | | | |
| the invention | | | | | | |
| pea protein isolate | 23.6 | 21.4 | 3.4 | 20.1 | 39.1 | 35.7 |
| No. 2 according to | | | | | | |
| the invention | | | | | | |
| Skimmed milk | 24.9 | 20.9 | 5.9 | 20.1 | 36.2 | 30.3 |
| MPC milk protein | 32.8 | 28.1 | 8.7 | 27.8 | 46.3 | 37.6 |
| from FONTERRA | | | | | | |
| MPC 80 Domo milk | 25.5 | 21.8 | 6.5 | 21.1 | 37.3 | 30.8 |
| protein from DMV | | | | | | |
| MPI Prodiet 87B | 25.4 | 22.6 | 6.9 | 21.4 | 39.1 | 32.2 |
| milk protein from | | | | | | |
| INGREDIA | | | | | | |
| Sodium caseinates | 31.9 | 25.3 | 6.3 | 25.3 | 43.6 | 37.3 |
| from DMV | | | | | | |

The pea protein isolates according to the invention have:
good emulsifying properties (lower Dmode: 23.4 and 23.6 μm, respectively)
Emulsion stability (AD) of the same order as or even lower than certain concentrated milk proteins or the sodium caseinates and
emulsion homogeneity equivalent to that of milk proteins.

Their properties moreover make them entirely transposable to applications in which a certain level of emulsifying power is required, such as iced dessert preparations or non-dairy coffee whitener, for which caseinates are sought.

### Example 1: Preparation of the Pea Protein Isolates According to the Invention and Characterization of the Pea Protein Isolates Referenced “1” and “2” According to the Invention

Process for Preparing the Pea Protein Isolates No. 1 According to the Invention

1500 kg of pea protein (sold by the Applicant Company under the brand name NUTRALYS® S85F) are mixed into 8500 liters of water preheated to 55° C.

The mixture is stirred for 3 hours at 55° C.

0.5% (weight/weight) of endoprotease FLAVORPRO 750 MDP (from the company BIOCATALYST) is added.

The mixture is stirred for 1 hour at 55° C.

The degree of hydrolysis obtained is then 7.

The reaction is inhibited by heating the medium to 70° C. and keeping it at this temperature for a minimum of 10 minutes.

A UHT treatment is applied (regime: 140° C.—10 seconds).

The mixture is dried by atomization to a solids content of about 93%.

Process for Preparing the Pea Protein Isolates No. 2 According to the Invention

1500 kg of pea protein (sold by the Applicant Company under the brand name NUTRALYS® S85F) are mixed into 8500 liters of water preheated to 55° C.

The mixture is stirred for 3 hours at 55° C.

0.3% (weight/weight) of endoprotease ENZECO FUNGAL PROTEASE (from the company EDC) is added.

The mixture is stirred for 1 hour at 55° C., and the degree of hydrolysis obtained is then 6.5.

The enzymatic reaction is inhibited by heating the medium to 70° C. and keeping it at this temperature for a minimum of 10 minutes.

A UHT treatment is applied (regime: 140° C.—10 seconds).

The mixture is then dried by atomization to a solids content of about 93%.

Characteristics of the Pea Protein Isolates Thus Prepared

1. Content of Free Amino Acids

Measurements taken according to standard NF EN ISO13903:2005

| | Free amino acids/sum of the |
|---|---|
| | amino acids (g/100 g crude |
| | percentage) |
| NUTRALYS ® S85F | 0.18 |
| pea protein isolate No. 1 | 0.77 |
| according to the invention | |
| pea protein isolate No. 2 | 1.85 |
| according to the invention | |

2. Viscosity Profile

For the determination of the viscosity profile in water, the measurements are taken
on an aqueous solution of pea protein isolates containing 15% solids (osmosed and azide-treated water at 200 ppm to prevent any bacteriological risk),
with an AR2000 rheometer from the company TA Instruments,
having concentric cylinder geometry,
with a shear rate of 0.6×10⁻³ at 600 s⁻¹ in 3 minutes (log) and
at a temperature of 20° C. (3 minutes of temperature equilibration before testing).

Before measurement, the solution is stirred for at least 10 hours, at 750 rpm and at 20° C.

The pH is not adjusted.

The following table compares the viscosity profiles of the pea protein isolates in accordance with the invention with those of the control milk proteins and of the pea protein NUTRALYS® S85F.

| Solution containing 15% solids | Viscosity in Pa · s at 20° C., spontaneous pH | | | | | | |
|---|---|---|---|---|---|---|---|
| Sample reference | 5 s⁻¹ | 10 s⁻¹ | 20 s⁻¹ | 40 s⁻¹ | 100 s⁻¹ | 200 s⁻¹ | 600 s⁻¹ |
| Pea protein NUTRALYS ® S85F | 15.820 | 9.538 | 5.700 | 3.570 | 1.900 | 1.251 | 0.680 |
| Milk protein MPC 4882 from | 0.030 | 0.032 | 0.030 | 0.029 | 0.029 | 0.028 | 0.026 |
| FONTERRA | | | | | | | |
| Milk protein Prodiet 27B Fluid | 0.022 | 0.021 | 0.019 | 0.017 | 0.015 | 0.014 | 0.013 |
| from INGREDIA | | | | | | | |
| Pea protein isolate No. 1 | 0.013 | 0.013 | 0.0135 | 0.011 | 0.010 | 0.010 | 0.010 |
| according to the invention | | | | | | | |
| Pea protein isolate No. 2 | 0.015 | 0.016 | 0.016 | 0.014 | 0.013 | 0.014 | 0.014 |
| according to the invention | | | | | | | |

It is found that the pea protein isolates in accordance with the invention show Newtonian behavior, like that of the milk proteins, whereas the pea protein NUTRALYS® S85F shows very pronounced shear-thinning behavior.

Furthermore, the viscosities of the pea protein isolates No. 1 and 2 are very close to the viscosities of the milk proteins, or even lower.

3. Solubility Profile in Water as a Function of the pH

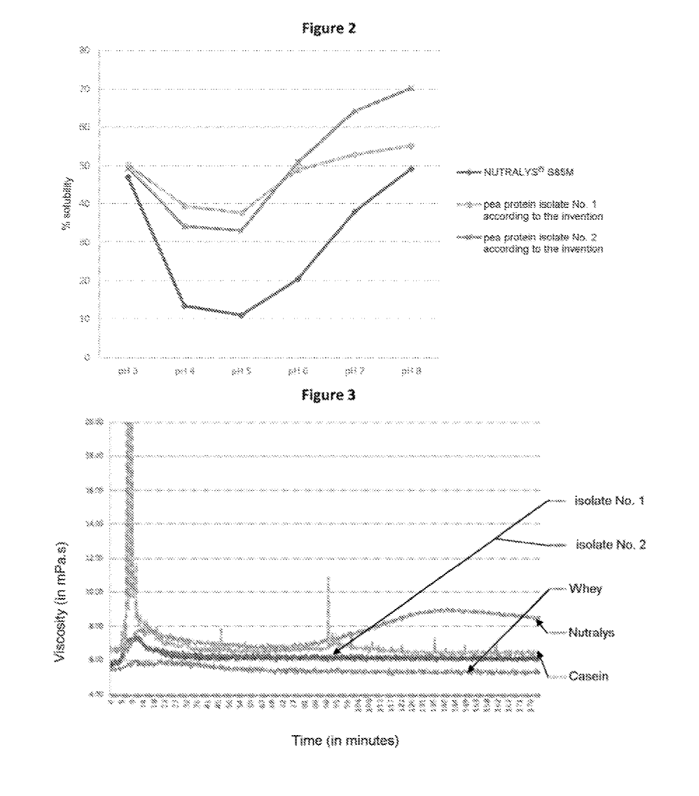

The results are presented in the following table and are illustrated by FIG. 2.

| | | Pea | Pea |
|---|---|---|---|
| | | protein | protein |
| | | isolate No. 1 | isolate No. 2 |
| | Pea protein | according | according |
| | NUTRALYS ® | to the | to the |
| Percentage | S85F | invention | invention |
| solubility | Mean on 7 samples | | |
| pH 3 | 47 | 50 | 49 |
| pH 4 | 13 | 39 | 34 |
| pH 5 | 11 | 38 | 33 |
| pH 6 | 20 | 49 | 51 |
| pH 7 | 38 | 53 | 64 |
| pH 8 | 49 | 55 | 70 |

4. Stability Study

A study of stability over time of the pea protein isolates in accordance with the invention is conducted so as to measure their behavior with regard to intact pea protein.

The study is conducted after six months of storage according to a temperature/relative humidity regime of:
40° C.±2° C.
at 75%±5% relative humidity.

The measurements are expressed as a percentage loss of solubility (measured according to the above procedure).

| | Pea | Pea | |
|---|---|---|---|
| | protein | protein | |
| | isolate No. 1 | isolate No. 2 | |
| | acording | according | Pea protein |
| | to the | to the | NUTRALYS ® |
| Percentage | invention | invention | S85F |
| solubility | After 6 months of storage | | |
| pH 3 | −12.2 | −27.7 | −44.0 |
| pH 4 | −10.8 | −14.8 | −18.4 |
| pH 5 | −6.9 | −9.8 | −5.2 |
| pH 6 | −8.5 | −14.7 | −19.6 |
| pH 7 | −8.8 | −19.9 | −47.4 |
| pH 8 | −5.9 | −22.0 | −57.9 |

It is thus found that, at pH 7, NUTRALYS® S85F loses about half of its solubility, whereas the pea protein isolates lose at most only a fifth of their solubility, and in all cases conserve higher solubility than that of the initial NUTRALYS® S85F.

4—Digestibility Profile

The aim of this study is to evaluate the total protein digestibility of the pea protein isolates No. 1 and 2 according to the invention and to compare it with NUTRALYS® S85F.

For this study, 48 Sprague Dawley rats (Charles River, Lyons, France) weighing 100-125 g at the start of the study were randomized as a function of their weight into four groups of 12 rats.

This experiment was performed in accordance with the European legislation on animal experimentation and with respect for animal well-being (APAFIS project No. 0000501).

On their arrival, the rats underwent a 7-day period of quarantine during which they received a standard feed for growing rats.

From the first day of the study, the rats received the following diets, for 10 days:

| | | | Pea | Pea |
|---|---|---|---|---|
| | | | protein | protein |
| | | | isolate | isolate |
| | | | No. 1 | No. 2 |
| | | Pea protein | according | according |
| | | NUTRALYS ® | to the | to the |
| | Control | S85F | invention | invention |
| | in % | in % | in % | in % |
| Test product | 0 | 12.5 | 12.4 | 12.5 |
| Microcrystalline | 5 | 5 | 5 | 5 |
| cellulose from MB | | | | |
| Biomedicals | | | | |
| Corn starch | 72.7 | 60.2 | 60.2 | 60.2 |
| qs 100% corn | 12.9 | 0.39 | 0.44 | 0.4 |
| starch | | | | |
| Soybean oil - | 7.5 | 7.5 | 7.5 | 7.5 |
| Huileries de | | | | |
| Sérignan | | | | |
| Sucrose | 10 | 10 | 10 | 10 |
| Maltodextrin | 0 | 0 | 0 | 0 |
| GLUCIDEX ® | | | | |
| IT21 | | | | |
| from ROQUETTE | | | | |
| FRERES | | | | |
| Choline bitartrate | 0.25 | 0.25 | 0.25 | 0.25 |
| t- | 0.0018 | 0.0018 | 0.0018 | 0.0018 |
| Butylhydroquinone | | | | |
| Mineral mixture | 3.5 | 3.5 | 3.5 | 3.5 |
| AIN-93G from MP | | | | |
| Biomedicals | | | | |
| Vitamin mixture | 1 | 1 | 1 | 1 |
| AIN-93-VX from | | | | |
| MP Biomedicals | | | | |

The amounts being indicated as weight percentages.

The consumption of feed and drink and the weight change are monitored on the first and fifth days of study and then daily up to the tenth and final day of study.

During the first five days of study, the urine and feces are also collected daily. The protein contents of the feeds and feces are determined via the Kjeldahl method (standard ISO 1871:2009).

The nitrogen analyses of the feces and feed make it possible to calculate the Coefficient of Digestive Use (CDU):

$$CDU ( \% ) = \frac{[ quantity absorbed - quantity excreted in the feces ]}{quantity absorbed}$$

All the rats had the expected growth. It was significantly lower in the protein-deficient control group, as always in this experimental scheme.

The consumption of drink was not modified by the various diets.

The changes in the other urinary and fecal parameters are directly associated with the control or experimental diet.

As a function of the various experimental days, the following digestibilities were calculated:

| | Digest- | | | | | | |
|---|---|---|---|---|---|---|---|
| | ibility (%) | | | | | | |
| Diet | CDU | D 6 | D 7 | D 8 | D 9 | D 10 | Mean |
| Pea protein | n | 12 | 12 | 12 | 12 | 12 | 12.00 |
| NUTRALYS ® | mean | 96.5 | 96.3 | 95.3 | 95.0 | 95.8 | 95.8 |
| S85F | standard | 2.6 | 1.4 | 1.4 | 1.7 | 1.9 | 0.8 |
| | deviation | | | | | | |
| Pea protein | n | 12 | 12 | 12 | 12 | 12 | 12.00 |
| isolate No. 1 | mean | 94.6 | 94.7 | 93.8 | 92.1 | 93.8 | 93.8 |
| according to | standard | 4.6 | 2.1 | 1.8 | 3.6 | 3.5 | 1.3 |
| the invention | deviation | | | | | | |
| Pea protein | n | 12 | 12 | 12 | 12 | 12 | 12.00 |
| isolate No. 2 | mean | 95.2 | 95.7 | 95.2 | 93.2 | 94.6 | 94.8 |
| according to | standard | 2.9 | 1.9 | 2.1 | 2.8 | 1.8 | 1.0 |
| the invention | deviation | | | | | | |

From a statistical viewpoint, the protein digestibility of NUTRALYSD S85F is significantly different from that of the pea protein isolate No. 1 according to the invention (p=0.0003).

However, from a biological viewpoint, these differences are totally insignificant.

It may thus be concluded that the digestibilities are similar between NUTRALYS and the pea protein isolates No. 1 and No. 2 according to the invention with the following rounding-up:

| Diet | | Global (rounded up) |
|---|---|---|
| Pea protein | mean | 96 |
| NUTRALYS ® | standard | 1 |
| S85F | deviation | |
| Pea protein | mean | 94 |
| isolate No. 1 | standard | 1 |
| according to the | deviation | |
| invention | | |
| Pea protein | mean | 95 |
| isolate No. 2 | standard | 1 |
| according to the | deviation | |
| invention | | |

5—Digestion Kinetics

This test uses an in vitro technique of simulation of protein digestion according to the following method.

The use of in vitro digestion methods allows efficient screening of various protein-rich food products as a function of their physicochemical properties and of their behavior during their passage through the stomach and the small intestine.

Here, a comparison is made of 3% (m/m) protein solutions for NUTRALYS® S85F, the pea protein isolates No. 1 and No. 2 according to the invention and the controls commonly used in tests of this type, namely casein and whey.

These five solutions are thus tested in an in vitro model of dynamic digestion under physiological conditions equivalent to the stomach and then the small intestine.

This digestion model is coupled with real-time monitoring of the viscosity using a controlled-stress rheometer (AR-2000, TA Instruments, New Castle, Del., USA) equipped with a stainless-steel fin rotor (height 39 mm and diameter 28 mm).

The protein solutions were tested under the same conditions, namely a regular shear at 37° C. and at a rate of 150 s⁻¹ for 3 hours.

The base viscosity was monitored for 5 minutes before performing gradual acidification of the solution down to a pH of between 1.5 and 2.

This acidification generally takes 15 minutes.

Once the pH of the solution has stabilized between 1.5 and 2, an enzymatic cocktail of stomach pepsin (Sigma-Aldrich, St. Louis, Mo., USA) and of lipase (Novozyme, Gladesaxe, Denmark) is added. The viscosity monitoring curves are presented in FIG. 3.

Monitoring of the viscosity during the in vitro digestion clearly reflects the digestion kinetics of the proteins. Thus, the digestion of whey does not give rise to a change in the viscosity since it is a rapidly digested protein. Casein, for its part, shows a greatly increased viscosity after acidification, which reflects slow digestion.

The pea protein of NUTRALYS® type demonstrates behavior intermediate between these two standards; it is qualified as being “rapid intermediate”.

However, the pea protein isolates No. 1 and No. 2 according to the invention show behavior that is again intermediate between NUTRALYS® S85F and whey.

It should be noted that the combination of rapid proteins with intermediate proteins may facilitate digestion and prolong the time of diffusion of the amino acids in the blood circulation, which is advantageous for protein synthesis in muscles after a long effort.

### Example 2: Replacement of Milk Protein with the Pea Protein Isolates in UHT-Treated Dessert Creams for Clinical Nutrition

The nutritive formulations based on milk, pea and competing pea protein and pea protein isolates according to the invention are presented in the following table (substitution of the order of 23%):

| | | Nutritional | Nutritional | Nutritional |
|---|---|---|---|---|
| | | formulation | for- | formulation |
| | Control | No. 2 | mulation | with |
| | for- | according to | with pea | competing |
| Ingredients | mulation | the invention | protein | pea protein |
| Demineralized | 64.30 | 64.30 | 64.30 | 64.30 |
| water | | | | |
| Sucrose | 12.40 | 12.40 | 12.40 | 12.40 |
| Milk protein | 12.00 | 9.60 | 9.60 | 9.60 |
| isolate (MPI - | | | | |
| Ingredia) | | | | |
| Rapeseed oil | 3.94 | 3.94 | 3.94 | 3.94 |
| Modified corn | 3.50 | 3.50 | 3.50 | 3.50 |
| starch | | | | |
| CLEARAM ® | | | | |
| CR3020 | | | | |
| (ROQUETTE | | | | |
| FRERES) | | | | |
| Maltodextrin | 1.70 | 1.70 | 1.70 | 1.70 |
| GLUCIDEX ® | | | | |
| IT19 | | | | |
| (ROQUETTE | | | | |
| FRERES) | | | | |
| Corn dextrin | 1.50 | 1.50 | 1.50 | 1.50 |
| NUTRIOSE ® | | | | |
| FM06 | | | | |
| Milk flavoring | 0.36 | 0.36 | 0.36 | 0.36 |
| Soybean lecithin | 0.30 | 0.30 | 0.30 | 0.30 |
| Pea protein | | 2.40 | | |
| isolate No. 2 | | | | |
| (according to the | | | | |
| invention - cf. | | | | |
| example 1 | | | | |
| above) | | | | |
| Pea protein | | | 2.40 | |
| NUTRALYS ® | | | | |
| S85F (ROQUETTE | | | | |
| FRERES) | | | | |
| Pea protein | | | | 2.40 |
| PISANE ® | | | | |
| (COSUCRA) | | | | |
| Total | 100 | 100 | 100 | 100 |

The amounts being indicated as weight percentages.

The nutritional values per 100 g are as follows:

| | | Nutritional | Nutritional | Nutritional |
|---|---|---|---|---|
| | | formulation | for- | formulation |
| | Control | No. 2 | mulation | with |
| | for- | according to | with pea | competing |
| | mulation | the invention | protein | pea protein |
| Calorific energy | 151 | 153 | 153 | 153 |
| (kCal) | | | | |
| Protein content (g) | 10.3 | 10.1 | 10.1 | 10.1 |
| Of which milk | 10.3 | 8.1 | 8.1 | 8.1 |
| protein | | | | |
| Of which pea | 0 | 0 | 0 | 0 |
| protein isolates | | | | |
| Of which pea | 0 | 2 | 2 | 2 |
| protein | | | | |
| Fat (g) | 4.7 | 4.9 | 4.9 | 4.9 |
| Carbohydrates (g) | 17.8 | 17.7 | 17.7 | 17.7 |
| Of which sucrose | 12.9 | 12.8 | 12.8 | 12.8 |
| Fiber (g) | 1.2 | 1.3 | 1.3 | 1.3 |
| Of which soluble | 1.2 | 1.3 | 1.3 | 1.3 |
| Of which insoluble | 0 | 0 | 0 | 0 |

The process for manufacturing the dessert creams is as follows:
Preheat the water to 50° C.,
Dry-mix all the powders (milk protein, pea protein, pea protein isolates, maltodextrins, dextrins, sucrose and starch),
Add the powder mix to the water at 50° C., disperse with a whip for 1 minute and then mix with a SILVERSON blender at 3000 rpm for 30 minutes at 50° C.,
Add the flavoring to said solution,
Place the lecithin and the oil in a separate mixing container, stir and heat to 50° C.,
After 30 minutes of hydration, add the lecithin and the oil mixture to the main batch, using a shear of 10 000 rpm for 5 minutes,
Sterilize the product at 133° C. for 55 seconds in a tubular exchanger and then package at 70° C.,
Store at 4° C.

Comparison of the Sensory Properties of Dessert Creams for Clinical Nutrition.

The panel is qualified for tasting formulated products. It received training so as to check its performance in terms of:
Capacity to discriminate the products
Consensus, correct use of the descriptors
Repeatability, ability to detect a product submitted twice

The panel consisted of 26 people, among the Roquette staff, and, on the day of tasting, 11 people were present, among whom six were specifically trained on the subject of dessert creams.

The products were prepared and then stored in a refrigerator.

They were served to the panelists at room temperature.

Tasting Conditions

In the sensory analysis laboratory: Individual tasting cubicles, white walls, calm environment (to facilitate concentration)
White light (to have exactly the same vision of the product)
At the end of the morning or the afternoon (to be at the height of the sensory capacities)
Products rendered anonymous with a three-figure code (to prevent the code from influencing the assessment of the products)
Products presented in a random order (to prevent order and persistence effects)

Exercise

The method employed to compare the products was the Flash Profile (J. M. Sieffermann, 2000).

The products are all presented simultaneously. It is a matter of comparing the products by making a succession of classifications: the panelists choose the descriptors which appear to them to be the most pertinent to discriminate between the products, and classify the products according to these descriptors; it is possible that several products are grouped in the same row.

### Example

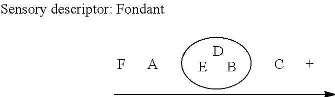

Here is the list of descriptors presented to the panelists as a guide:

DESSERT CREAMS

| | | | |
|---|---|---|---|
| Descriptor | Definition | Procedure | Reference |

APPEARANCE

| | | | |
|---|---|---|---|
| Glossy | which reflects light | explore the product visually | Raw egg yolk |
| | (not glossy/very glossy) | | |
| Granular | which contains particles | explore the product visually | Brown sugar |
| (appearance) | (numerous and/or large-sized) | | |
| | (not granular/very granular) | | |

TASTE

| | | | |
|---|---|---|---|
| Sweet | Elementary taste generated by a | Taste the product | Caster sugar |
| | sucrose solution | | |
| Bitter | Elementary taste which gives a | Taste the product | Caffeine/coffee |
| | sour, unpleasant sensation, with | | |
| | a caffeine solution | | |
| Pea | has a pea taste | Taste the product | Pea |

TEXTURE
spoonful

| | | | |
|---|---|---|---|
| Thick | resists flowing | evaluate the stress resistance of | Honey |
| (spoon) | (not thick/very thick) | the product by turning the spoon in | |
| | | the jar | |
| Short | forms a thin flow trickle/falls in | Take up a product unit with a | SojaSun |
| | blobs | spoon. Raise and turn the spoon | |
| | (long/short texture) | over. Check the length of the flow | |
| | | trickle | |

Mouthfeel
Initial phase (perception when first placed in the mouth)

| | | | |
|---|---|---|---|
| Thick | flows with difficulty in the mouth | put a product unit in the mouth and | Mascarpone |
| (in the | (not thick/very thick) | move it around the oral cavity | |
| mouth) | | | |

Chewing phase (perception during chewing)

| | | | |
|---|---|---|---|
| Fondant | Evaluation of the dissolvability of | keep moving the product around in | Ice cream |
| | the product in the mouth by the | the mouth and evaluate the time | |
| | action of the saliva. | taken to dissolve it. | |
| | (not fondant/very fondant) | | |
| Creamy | has a soft contact and melts in the | put a product unit in the mouth and | Thick creme |
| | mouth | check whether it gives a soft | fraiche |
| | (not creamy/very creamy) | contact and whether it lines the | |
| | | oral cavity | |
| Granular | contains particles | slide the tongue against the palate | Brown sugar |
| (in the | (smooth/very granular) | and evaluate the perception of | |
| mouth) | | small grains in the mouth | |

Residual phase (changes arising during chewing)

| | | | |
|---|---|---|---|
| Tacky | adheres to the walls of the oral | place a sample on the tongue, | Soft caramel |
| | cavity | press it against the palate and | |
| | (not tacky/very tacky) | evaluate the force required to | |
| | | remove it with the tongue | |

Data Processing

The statistical processing method suited to this type of data is multiple factor analysis (J. Pagès, 1994) on the data-rows of the products. In order for the results to be clearer, the MFA was performed several times; globally, and per criterion (aspect, odor, taste, texture). The graphs presented summarize all of the results provided by this method.

The statistical processing was performed with the software R version 2.14.1 (2011 Dec. 22).

Results

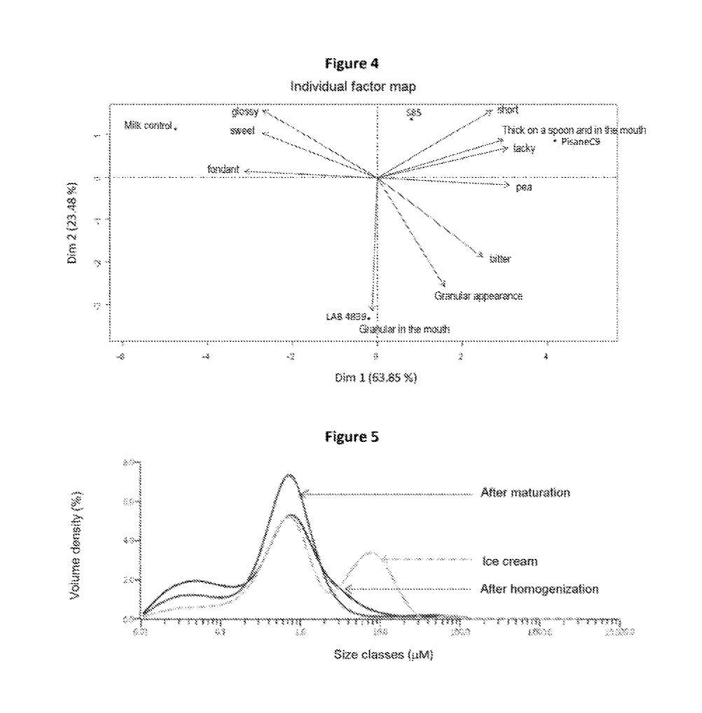

As is seen in FIG. 4, the dessert creams are consensually discriminated by all the panelists with a very high dimension 1 at almost 64% which describes the extreme products in the following manner.

The milk control has the glossiest appearance and melts in the mouth, but is the least thick and has the sweetest taste.

Regarding the texture, the dessert creams with PISANE® C9 and NUTRALYS® S85F are thicker than those with the pea protein isolate according to the invention.

Regarding the taste, the dessert cream with the pea protein isolate is less pea than the test with PISANE® C9 and NUTRALYS® S85F.

### Example 3. Replacement of Milk Protein with the Pea Protein Isolates in Ice Creams/Iced Desserts

Four recipes are developed:
Control: with 100% milk protein
Recipe No. 1: 50% milk protein replaced with the pea protein NUTRALYS® S85F;
Recipe No. 2: 50% milk protein replaced with the pea protein isolate No. 1 according to the invention:
Recipe No. 3: 50% milk protein replaced with the pea protein isolate No. 2 according to the invention;

| | Control | Recipe No. 1 | Recipe No. 2 | Recipe No. 3 |
|---|---|---|---|---|
| Water | 48.70 | 48.77 | 48.79 | 48.79 |
| Sucrose | 13.00 | 13.00 | 13.00 | 13.00 |
| Cream (35% fat) | 27.40 | 27.40 | 27.40 | 27.40 |
| Lactose | 0.00 | 2.10 | 2.10 | 2.10 |
| Skimmed milk | 5.80 | 2.05 | 2.05 | 2.05 |
| powder | | | | |
| 70/81 Glucose syrup | 4.00 | 4.00 | 4.00 | 4.00 |
| Pea protein | 0.00 | 1.58 | 0.00 | 0.00 |
| NUTRALYS ® | | | | |
| S85F | | | | |
| Pea protein isolate | 0.00 | 0.00 | 1.56 | 0.00 |
| No. 1 according to | | | | |
| the invention | | | | |
| Pea protein isolate | 0.00 | 0.00 | 0.00 | 1.56 |
| No. 2 according to | | | | |
| the invention | | | | |
| Stabilizers | 0.60 | 0.60 | 0.60 | 0.60 |
| (CREMODAN | | | | |
| SE30) | | | | |
| Vanilla flavoring | 0.50 | 0.50 | 0.50 | 0.50 |
| IFF 10836706 | | | | |
| TOTAL | 100.00 | 100.00 | 100.00 | 100.00 |

The amounts being indicated as weight percentages.

Nutritional values per 100 g

| | | | | |
|---|---|---|---|---|
| Energy (kCal) | 181.75 | 174.63 | 174.47 | 168.31 |
| Fat (g) | 10.03 | 10.15 | 10.15 | 10.15 |
| Carbohydrates (g) | 20.33 | 20.30 | 20.33 | 20.30 |
| Of which sugars (g) | 19.59 | 17.54 | 17.55 | 17.54 |
| Proteins (g) | 2.53 | 2.50 | 2.50 | 2.50 |
| Of which milk | 2.53 | 1.25 | 1.25 | 1.25 |
| protein (g) | | | | |
| Of which plant | 0.00 | 1.25 | 1.25 | 1.25 |
| protein (g) | | | | |
| Fiber (g) | 0.14 | 0.14 | 0.14 | 0.14 |
| Solids (%) | 33.98 | 33.85 | 33.86 | 33.87 |
| Lactose (%) | 4.09 | 4.06 | 4.06 | 4.06 |
| ESDL (%) | 3.84 | 3.95 | 3.95 | 3.95 |
| Degree of | 0 | 50 | 50 | 50 |
| substitution of the | | | | |
| milk protein (%) | | | | |

The manufacturing process is as follows:
Add the skimmed milk to the container (40/45° C.),
Add the powdered ingredients to the container and stir for 15 minutes at 80 Hz in a CHOCOTEC batch cooker,
Mix together the stabilizers and the sugar, then incorporate the mixture into the container,
Mix for 20 minutes at 80 Hz,
Incorporate the cream and the glucose syrup,
Mix for 15 minutes at 80 Hz,
Pasteurize at 80° C. for 3 minutes,
Cool to 70° C.—Half of the mixture obtained is homogenized directly; the other half is cooled to 50° C. When the first batch is homogenized, the second batch is heated to 70° C. and then homogenized,
Homogenize at 200 bar,
Cool in the maturation container to 4° C. and add the flavoring,
Leave to mature for 23 hours,
Beat to obtain an overrun of 95-100% and freeze at −30° C. to 1 hour,
Store the ice cream at −20° C.

Analyses

Characterization of the Mixtures During the Manufacturing Process

| | Control | Recipe No. 1 | Recipe No. 2 | Recipe No. 3 |
|---|---|---|---|---|
| pH before maturation | 6.72 (0.5° C.) | 7.00 (1° C.) | — | 6.90 (0.6° C.) |
| pH after maturation | 6.73 (−1.5° C.) | 7.07 (0.1° C.) | 6.82 (−2.4° C.) | 7.01 (−2° C.) |
| Overrun of the | 103 | 111 | 97 | 98 |
| mixture (%) | | | | |
| Outlet temperature | −5.4 | −5.6 | −6 | −5.6 |
| (° C.) | | | | |

It is noted that the expandability of the preparations made with the pea protein isolates in accordance with the invention is identical to that of the control and is not significantly different from that made with pea protein.

Viscosity Measurements

Visosity (Pa · s)

| | Maturation | 10 s−1 | 100 s−1 |
|---|---|---|---|
| Control | Before | 0.24 | 0.098 |
| | After | 0.23 | 0.095 |
| Recipe No. 1 | Before | 0.36 | 0.18 |
| | After | 0.35 | 0.2 |
| Recipe No. 2 | Before | 0.18 | 0.10 |
| | After | 0.18 | 0.10 |
| Recipe No. 3 | Before | 0.2 | 0.11 |
| | After | 0.16 | 0.098 |

The recipe with pea protein shows the highest viscosities. The recipes with pea protein isolate in accordance with the invention are equivalent to the control recipe.

Particle Size Analysis

The particle size analysis was performed at various steps in the preparation of the ice cream for the purpose of evaluating the emulsifying capacity and the stability of the emulsion:
Size distribution of the fat globules after the homogenization step,
Size distribution of the fat globules after the maturation step,
Size distribution of the fat globules of the ice cream (equivalent to the size distribution of the fat globules after the beating step).

These analyses were also performed with addition of 0.1% SDS so as to determine whether the emulsion was created by aggregation/flocculation or by coalescence.

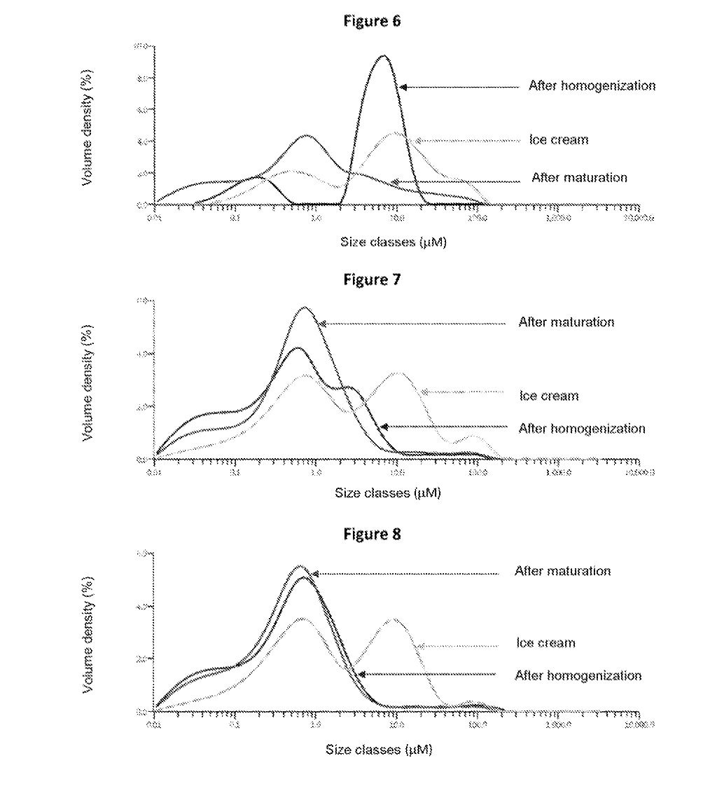

The results are presented in FIGS. 5 to 8.

For each recipe, the particle size distribution tends to decrease or to become more monomodal after maturation.

This change is very perceptible for the recipe with the pea protein NUTRALYS® S85F. This shows that the pea protein NUTRALYS® S85F is the slowest emulsifier for migrating at the interface of the fat globules.

In contrast, recipe No. 3 (with the pea protein isolate No. 2 in accordance with the invention) is just as good an emulsifier as the recipe containing 100% milk protein.

The pea protein isolate No. 1 in accordance with the invention is less emulsifying than the pea protein isolate No. 2 in accordance with the invention after homogenization, but has a tendency to become just as good after maturation.

### Example 4: Total Substitution of Milk Protein for the Pea Protein Isolates in Ice Creams/Iced Desserts

Three recipes were developed for these vegan ice creams:
Control: 100% pea protein NUTRALYS® S85F,
Recipe 1: 100% pea protein isolate No. 1 according to the invention,
Recipe 2: 100% pea protein isolate No. 2 according to the invention

| | Control | Recipe 1 | Recipe 2 |
|---|---|---|---|
| Water | 64.25 | 64.25 | 64.25 |
| Sucrose | 12.00 | 12.00 | 12.00 |
| Hydrogenated coconut oil | 8.00 | 8.00 | 8.00 |
| Glucose syrup Roquette 4280 | 11.50 | 11.50 | 11.50 |
| NUTRALYS ® S85F | 3.50 | 0.00 | 0.00 |
| Stabilizers | 0.25 | 0.25 | 0.25 |
| (CREMODAN SE30) | | | |
| Vanilla flavoring | 0.50 | 0.50 | 0.50 |
| IFF 10836706 | | | |
| Pea protein isolate No. 1 | 0.00 | 3.50 | 0.00 |
| according to the invention | | | |
| Pea protein isolate No. 2 | 0.00 | 0.00 | 3.50 |
| according to the invention | | | |
| Total | 100% | 100% | 100% |

The amounts being indicated as weight percentages.

The nutritional values (per 100 g) are as follows:

| | Control | Recipe 1 | Recipe 2 |
|---|---|---|---|
| Energy value (kcal) | 172 | 172 | 172 |
| Total fat | 8.5 | 8.5 | 8.5 |
| of which saturated fat | 7.6 | 7.6 | 7.6 |
| Carbohydrates, without | 21.2 | 21.2 | 21.2 |
| fiber | | | |
| of which sugars | 14.6 | 14.6 | 14.6 |
| Fiber | 0.1 | 0.1 | 0.1 |
| Protein | 2.8 | 2.8 | 2.8 |
| Salt (sodium × 2.5) | 0.11 | 0.14 | 0.14 |
| Solids | 33.1 | 33.2 | 33.2 |

The manufacturing process is as follows:
Heat the water to 45° C.,
Mix the ingredients,
Mix the stabilizers with the sucrose,
Add the water and mix for 20 minutes,
Introduce the fat (melted coconut oil) and mix,
Pasteurize at 80° C. for 3 minutes,
Cool to 70° C.,
Homogenize the mixture at 200 bar (in two stages)—30% in the 2^{nd} stage,
Add the flavoring,
Leave to mature with stirring at 4° C. for 20 minutes,
Beat to between 90-100% and cool at −30° C. for 1 hour,
Store at −18° C.

Analyses

Measurement of the Overrun Power (Iced Desserts)
Weight of an empty crucible of given volume V,
Measured mass=m_{c} in which m_{c} is the mass of the empty crucible
Weight of a crucible of given volume V, filled to the brim with the mixture before overrun
Measured mass=mc+mₘᵢₓ in which mₘᵢₓ is the mass of mixture corresponding to the volume V
Weight of a crucible of given volume V, filled to the brim with the mixture after overrun (taken from the freezer)
Measured mass=mc+m_{ice} in which m_{ice} is the mass of ice (overrun mixture taken from the freezer) corresponding to the volume V.

The overrun measurement is then given by the formula:

$$Overrun = \frac{( {m}_{mix} - {m}_{ice} )}{{m}_{ice}} \times 100$$

Characterization of the Preparation Process

| | Control | Recipe 1 | Recipe 2 |
|---|---|---|---|
| pH after maturation | 7.25 | 6.84 | 6.89 |
| Density of the mixture | 1.05 | 1.06 | 1.07 |
| (g/ml) | | | |
| Overrun power (%) | 89 | 80 | 101 |
| Temperature on leaving | −5 | −4.8 | −4.8 |
| the freezer | | | |

Viscosity Measurement
Measurements taken at 4° C.
Rheometer. Physica MCR 301 Anton Paar
Geometry: concentric cylinder CC27
Nominal value: 0 to 200 s⁻¹ in 5 minutes

| | Viscosity (mPa · s) | | |
|---|---|---|---|
| Reference | 10 s⁻¹ | 100 s⁻¹ | 200 s⁻¹ |
| Before maturation | | | |
| Control | 131 | 60 | 50 |
| Recipe 1 | 23 | 51 | 40 |
| Recipe 2 | 22 | 50 | 39 |
| After maturation | | | |
| Control | 120 | 65 | 56 |
| Recipe 1 | 76 | 50 | 48 |
| Recipe 2 | 74 | 50 | 44 |

It is thus noted that the viscosity is lower when the recipe comprises pea protein isolates according to the invention.

Measurement of the Texture
Measurement temperature: on leaving the freezer,
Rheometer: INSTRON 9506 machine
Geometry: conical
Nominal value: imposed deformation up to 20 minutes,

| Freezer storage time | Hardness (N) | | |
|---|---|---|---|
| before measurement | 7 days | 14 days | 30 days |
| Control | 38.4 | 42.7 | 60.5 |
| Recipe 1 | 126.2 | 128.4 | 137 |
| Recipe 2 | 76 | 67.9 | 63 |

It is found that the hardness is globally better for the recipes with the pea protein isolates according to the invention. More particularly, the pea protein isolate No. 2 according to the invention has a remarkably high hardness, no doubt in relation to its higher overrun power (101%).

Measurement of the Size of the Emulsion of the Mixture and of the Iced Dessert

Protocol:
MALVERN 3000 liquid-route particle size analyzer (granulometer) (the solvent is demineralized water)
Optical model: 1.46+0.001i with a stirring speed of 1900 rpm.

The mixtures before and after maturation are characterized with and without SDS:
Without SDS: the sample is introduced directly into the particle size analyzer beaker containing only water,
With SDS: 0.1%, i.e. 0.6 g, of SDS is introduced directly into the beaker of the particle size analyzer After dissolution of the SDS, the sample is added for analysis.

The final ice cream is introduced unthawed into the bowl of the particle size analyzer. After melting and dispersing the ice cream, the measurement is taken.

The size of the emulsion, before and after maturation, with and without SDS, is given in the following table.

| Before maturation, | Dx (10) | Dx (50) | Dx (90) | Dmode | D (4.3) |
|---|---|---|---|---|---|
| without SDS | μm | μm | μm | μm | μm |
| Control | 0.073 | 0.377 | 3.380 | 0.429 | 1.410 |
| Recipe 1 | 0.693 | 10.300 | 22.200 | 13.000 | 11.400 |
| Recipe 2 | 0.520 | 8.400 | 18.200 | 10.000 | 9.310 |

Without SDS, the emulsion of the mixture containing pea protein (control) has a smaller particle size than the emulsions prepared from the pea protein isolates according to the invention.

| Before maturation, with | Dx (10) | Dx (50) | Dx (90) | Dmode | D (4.3) |
|---|---|---|---|---|---|
| SDS | μm | μm | μm | μm | μm |
| Control | 0.103 | 0.340 | 1.010 | 0.389 | 0.698 |
| Recipe 1 | 0.065 | 0.605 | 5.110 | 0.621 | 1.650 |
| Recipe 2 | 0.115 | 0.503 | 1.830 | 0.564 | 0.913 |

With SDS, the fat agglomerates are dispersed, and the Dmode is thus closer for the three tests. It should be noted that the formulation with the pea protein isolate No. 1 according to the invention has a particle size analysis peak with larger particles.

| | Dx (10) | Dx (50) | Dx (90) | Dmode | D (4.3) |
|---|---|---|---|---|---|
| | μm | μm | μm | μm | μm |
| After maturation, without | | | | | |
| SDS | | | | | |
| Control | 0.085 | 0.379 | 2.690 | 0.433 | 1.210 |
| Recipe 1 | 0.102 | 5.300 | 16.200 | 8.470 | 6.780 |
| Recipe 2 | 0.088 | 4.460 | 15.400 | 7.820 | 6.150 |
| After maturation, with | | | | | |
| SDS | | | | | |
| Control | 0.103 | 0.329 | 0.894 | 0.381 | 0.658 |
| Recipe 1 | 0.039 | 0.509 | 4.830 | 0.616 | 1.620 |
| Recipe 2 | 0.098 | 0.504 | 2.070 | 0.573 | 1.110 |

No major change is observed after maturation. The formulations with the pea protein isolates according to the invention are more polydisperse than the formulation with the pea proteins.

The emulsion size of the ice cream, in unmodified form, is measured without the presence of SDS.

| | Dx (10) | Dx (50) | Dx (90) | Dmode | D (4.3) |
|---|---|---|---|---|---|
| Without SDS | μm | μm | μm | μm | μm |
| Control | 0.092 | 0.333 | 3.950 | 0.352 | 2.390 |
| Recipe 1 | 0.131 | 0.776 | 15.900 | 0.531 | 5.820 |
| Recipe 2 | 0.178 | 0.814 | 51.400 | 0.518 | 14.500 |

The size of the major peak (Dmode) is similar for the three ice creams. However, the formulations with the pea protein isolates according to the invention are more polydisperse, especially with the isolate No. 2.

A comparative study was performed with commercial ice creams, which show that these ice creams contain an even larger number of coarse particles than the control recipes and recipes 1 and 2 in relation to their high content of fat globules.

Measurement of the Melting Behavior

Protocol:

Empirically, samples of iced desserts of a given volume are placed on a grille above a beaker. The following are then measured:
The time after which the first drop falls into the beaker,
The percentage of ice cream melted over time, over 3 hours.

FIG. 9 clearly illustrates the fact that the melting is lesser for the ice creams prepared with the pea protein isolates according to the invention.

Sensory Analysis

The panel consisted of 15 people.

The panel, as in the preceding examples, is qualified for tasting products formulated with pea protein. It received training so as to check its performance in terms of:
Capacity to discriminate the products
Consensus, correct use of the descriptors
Repeatability, ability to detect a product submitted twice.

When compared with the ice creams prepared with pea protein, those of the invention are less bitter, have less of a pea taste and are less colored.

The iced desserts with the pea protein isolates No. 1 according to the invention have a few ice crystals and a more pronounced vanilla taste, are sweeter, and fatter than the other products.

The iced desserts with the pea protein isolates No. 2 according to the invention are sweet and fatty, and more creamy. They have a slightly more pronounced “green tea” taste.

Conclusion

During the process of manufacturing the iced desserts, the pea protein isolates according to the invention lead to a lower viscosity in comparison with pea protein.

The texture of isolate No. 1 is harder, but is not perceived by the panelists.

The two isolates lead above all to lowering the melting of the corresponding iced desserts.

In terms of taste, the best perception is for the iced desserts prepared with isolate No. 1, of sweet taste and pronounced flavor, less bitterness and less “pea” taste.

### Example 5: Comparison of the Sensory Properties of Ice Creams

The panel consisted of 20 people.

The panel is qualified for tasting products formulated with pea protein. It received training so as to check its performance in terms of:
Capacity to discriminate the products
Consensus, correct use of the descriptors
Repeatability, ability to detect a product submitted twice

Specifically, it received training in the correct use of the sensory descriptors of taste and texture, for instance:

| | | | |
|---|---|---|---|
| Descriptor | Definition | Procedure | Reference |

Flavors

| | | | |
|---|---|---|---|
| Pea taste | Typical pea taste. | Taste the product. | Pea |
| Sweet | Elementary taste | Taste the product. | Caster sugar |
| | generated by a sucrose | | |
| | solution. | | |

Mouthfeel

| | | | |
|---|---|---|---|
| Hard | Evaluation of the force | Press a product unit | Confectionery |
| | required to obtain | between the incisors. | of cooked |
| | deformation or rupture of | | sugar type |
| | the product. | | |
| | (not hard/very hard) | | |
| Aerated | Evaluation of the amount | Explore visually and by | Chocolate |
| | of air bubbles trapped and | touch by placing a finger | mousse |
| | visible. | parallel to the surface | |
| | (not aerated/very aerated) | state and exert different | |
| | | pressures from top to bottom. | |
| Aqueous | Evaluation of the surface | Taste a product unit and | Watermelon |
| | texture property qualifying | evaluate the amount of | |
| | the perception of the | water perceived in the | |
| | amount of water released | mouth. | |
| | by a product. | | |
| | (not aqueous/very | | |
| | aqueous) | | |
| Water | Evaluation of the presence | Rub the tongue against | Recrystallized |
| crystals | of water crystals | the palate and check | ice |
| | (no crystals/many crystals) | whether the product | |
| | | contains crystals | |
| Greasy | Evaluation of the greasy | After swallowing a | Olive oil |
| | film after swallowing. | product unit, evaluate | |
| | (not greasy/very greasy) | the presence or | |
| | | absence of a greasy film | |
| | | on the palate or on the | |
| | | teeth by sweeping over | |
| | | their surface with the | |
| | | tongue. | |

The method also allows them to make comments on other descriptors that were not anticipated in this list.

Products

The ice creams are recipes No. 1, No. 2 and No. 3 those of Example 9.

Tasting conditions
In a sensory analysis laboratory: individual tasting cubicles, white walls, calm environment (to facilitate concentration)
White light (to have exactly the same vision of the product)
At the end of the morning or the afternoon (to be at the height of the sensory capacities)
Products rendered anonymous with a three-figure code (to prevent the code from influencing the assessment of the products)
Products presented in a random order (to prevent order and persistence effects)

Exercise

The method employed to compare the products was the Flash Profile (J. M. Sieffermann, 2000).

The products are all presented simultaneously. It is a matter of comparing the products by making a succession of classifications: the panelists choose the descriptors which appear to them to be the most pertinent to discriminate between the products, and classify the products according to these descriptors; it is possible that several products are grouped in the same row.

### Example

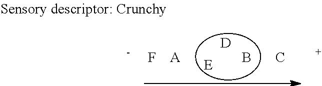

Data Processing

The statistical processing method suited to this type of data is multiple factor analysis (J. Pagès, 1994) on the data-rows of the products. In order for the results to be dearer, the MFA was performed several times; globally, and per criterion (aspect, odor, taste, texture). The graphs presented summarize all of the results provided by this method.

The analyses were performed using the R software (on open sale):

R version 2.14.1 (2011-12-22)

Copyright (C) 2011 The R Foundation for Statistical Computing

ISBN 3-900051-07-0

20 Platform: i386-pc-mingw32/i386 (32-bit)

The software is a working environment which requires the loading of modules containing the calculation functions such as the FactoMineR version 1.19 package.

Results

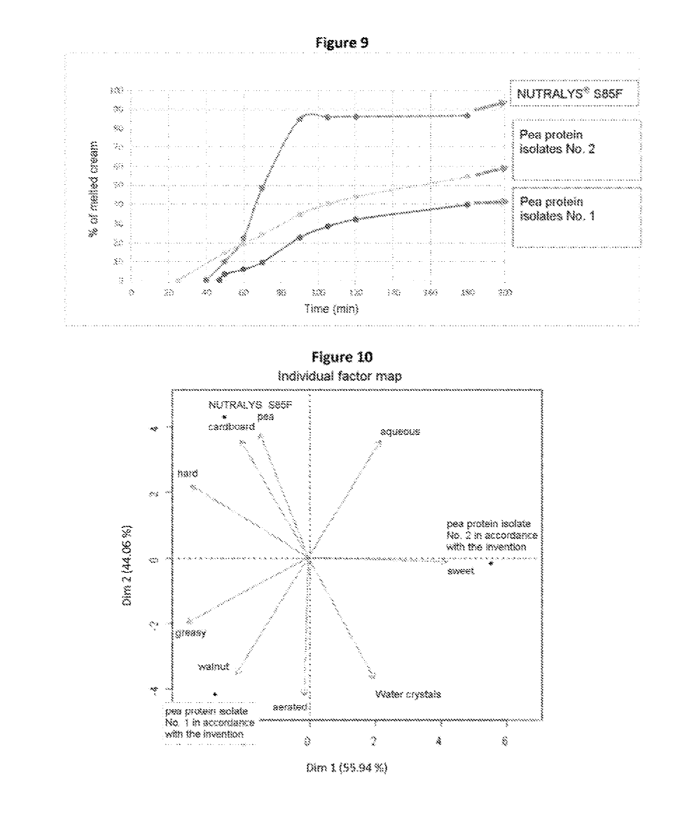

The results are shown in FIG. 10.

The three samples are all evaluated in terms of creamy texture, cold and fondant and in terms of pea, vanilla and bitter taste.

However, a few descriptors allow them to be differentiated:
The ice cream with NUTRALYS® S85F appears harder with a pea and cardboard taste.
The one with pea protein isolate No. 1 in accordance with the invention is more greasy and aerated with a walnut note.
The one with pea protein isolate No. 2 in accordance with the invention is judged to be sweeter.

### Example 6: Use of the Pea Protein Isolates in “Non-Dairy Coffee Creamer/Whitener” Matrices

a. 100% Substitution for Sodium Caseinates

The object here is to substitute 100% of the sodium caseinates and to obtain a product that is stable in coffee.

Measurement of the viscosity of the emulsions after pasteurization and measurement of the stability in coffee make it possible to illustrate the improvement in the functional properties of the pea protein isolates relative to NUTRALYS® in their ability to substitute for sodium caseinates.

The recipes developed are as follows:

| | | Recipe 2 | Recipe 3 | |
|---|---|---|---|---|
| | | 100% | 100% | |
| | | pea | pea | |
| | Recipe 1 | protein | protein | |
| | (Control | isolate | isolate | |
| | Recipe) | No. 1 | No. 2 | |
| | 100% | according | according | Recipe 4 |
| | sodium | to the | to the | 100% |
| | caseinate | invention | invention | NUTRALYS ® |
| | (60% | (60% | (60% | S85F |
| | solids) | solids) | solids) | (60% solids) |
| | % | % | % | % |
| Glucose syrup | 45.85 | 45.85 | 45.85 | 45.85 |
| 3072 | | | | |
| (Roquette | | | | |
| FRERES) | | | | |
| Hydrogenated | 23.36 | 23.36 | 23.36 | 23.36 |
| coconut oil 32- | | | | |
| 34 (Dislab) | | | | |
| NUTRALYS ® | | | | 1.75 |
| S85F batch | | | | |
| WB67J | | | | |
| Pea protein | | 1.75 | | |
| isolate No. 1 | | | | |
| according to | | | | |
| the invention | | | | |
| Pea protein | | | 1.75 | |
| isolate No. 2 | | | | |
| according to | | | | |
| the invention | | | | |
| Sodium | 1.75 | | | |
| caseinate EM7 | | | | |
| (DMV) | | | | |
| K₂HPO₄_E340 | 1.46 | 1.46 | 1.46 | 1.46 |
| (Merck) | | | | |
| Dimodan | 0.58 | 0.58 | 0.58 | 0.58 |
| HP_E471 | | | | |
| (Danisco) | | | | |
| Water | 27.00 | 27.00 | 27.00 | 27.00 |
| TOTAL | 100.00 | 100.00 | 100.00 | 100.00 |

The amounts being indicated as weight percentages.

The manufacturing process is as follows:
Melt the fat at 80° with constant stirring,
Add the Dimodan HP to the melted fat to dissolve the monoglycerides,
Heat 90% of the water to 50° C. and add the proteins, Hydrate with constant stirring for 30 minutes,
Dissolve the phosphate salts in the residual water at 40° C.,
After 30 minutes of hydration, add the glucose syrup and the phosphate salts to the main mixture,
Pre-emulsify the mixture of fat/Dimodan HP in the main mixture for 5 minutes at 10 000 rpm,
Place the product at 75° C. in a Niro Panda 2K Soavi (GEA) high-pressure homogenizer at a pressure of 160 bar in the first stage, and 30 bar in the second stage,
Pasteurize at 80° C. for a few seconds and then place the product in cold water to stop the heat treatment.

The analyses performed on the formulation are as follows:

1. Viscosity Analysis

The viscosity measurements on the concentrated emulsions after the heat treatment step are performed at 65° C., the usual atomization temperature.

Apparatus:
Physica MCR 301 Anton Paar rheometer
Geometry: CC27
Method 0 to 1000 s⁻¹ in 660 s

The results obtained on the various recipes are as follows:

| | Viscosity (mPa · s) | | | | |
|---|---|---|---|---|---|
| | 5 s−1 | 10 s−1 | 40 s−1 | 100 s−1 | 1000 s−1 |
| Control recipe | 89 | 69 | 47 | 44 | 42 |
| Recipe 2 | 77 | 59 | 40 | 34 | 24 |
| Recipe 3 | 77 | 60 | 42 | 36 | 26 |
| Recipe 4 | 775 | 530 | 270 | 197 | 85 |

The viscosities of the emulsions of recipes 2 and 3 after pasteurization are closer to the milk control than that of recipe 4 prepared with pea protein, which makes it possible to dry a low-viscosity emulsion with a high solids content as here at 60% by weight.

2. Solubility as a Function of the pH

| | | Pea protein | Pea protein | Sodium |
|---|---|---|---|---|
| | | isolate No. 1 | isolate No. 2 | caseinate |
| | NUTRALYS | according to | according to | EM7 |
| | S85F | the invention | the invention | (DMV) |
| pH 3 | 50.3 | 53.3 | 58.9 | 82.0 |
| pH 4 | 15.2 | 39.7 | 38.6 | 7.0 |
| pH 5 | 11.3 | 37.7 | 36.8 | 9.0 |
| pH 6 | 21.2 | 50.3 | 53.9 | 94.0 |
| pH 7 | 36.8 | 54.8 | 59.9 | 94.0 |
| pH 8 | 55.1 | 57.4 | 62.4 | 94.0 |

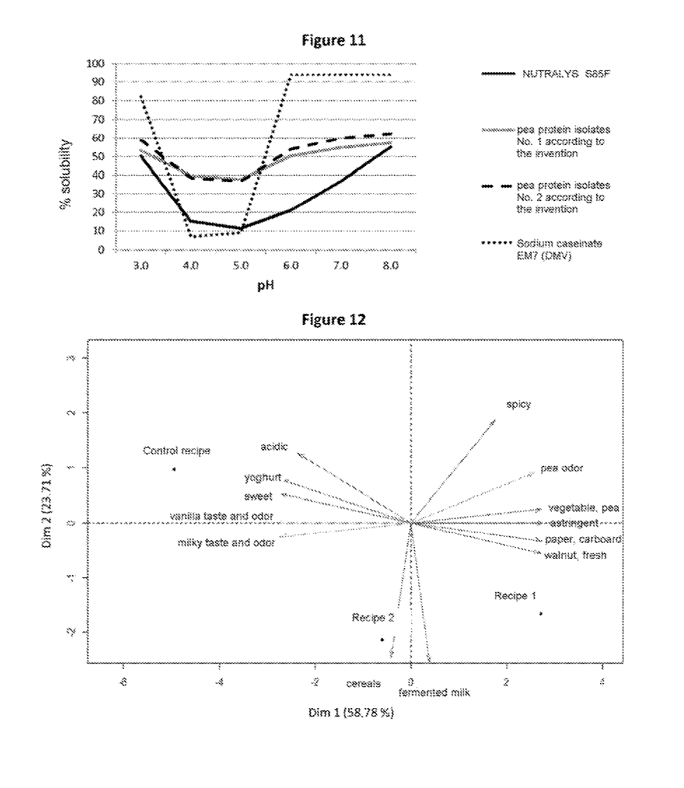

FIG. 11 illustrates the change in solubility of the pea protein isolates according to the invention relative to caseinate, as a function of the pH, and reflects their excellent behavior.

### Evaluation of the Stability in Coffee

Reconstitution of Coffee
Weigh out 2 g of soluble coffee:
heat drinking water (calcium content of 136 mg and magnesium content of 60 mg) at 80° C. and add 135 g of said water to the 2 g,
add 12.7 g of concentrated emulsion to the coffee.

The flocculation in the coffee appears to be less substantial with the recipes containing the pea protein isolates according to the invention, relative to that obtained with pea protein. However, this may be correlated with the improvement in solubility of said isolates relative to pea protein.

a. 50% Substitution for Sodium Caseinates

The object here is to substitute 50% of the sodium caseinates and to obtain a product that is stable in coffee.

Measurement of the viscosity of the emulsions after pasteurization and measurement of the stability in coffee make it possible to illustrate the improvement in the functional properties of the pea protein isolates relative to NUTRALYS® in their ability to substitute for sodium caseinates.

The recipes developed are as follows:

| | | Recipe 2 | |
|---|---|---|---|
| | | 50% pea | |
| | | protein | |
| | | isolate | |
| | | No. 2 | |
| | Recipe 1 | according | |
| | (Control | to the | Recipe 3 |
| | Recipe) | invention + | 50% |
| | 100% | 50% | NUTRALYS ® |
| | sodium | sodium | S85F + 50% |
| | caseinate | caseinate | sodium |
| | (60% | (60% | caseinate |
| | solids) | solids) | (60% solids) |
| | % | % | % |
| Glucose syrup 3072 | 45.85 | 45.85 | 45.85 |
| (Roquette FRERES) | | | |
| Hydrogenated coconut | 23.36 | 23.36 | 23.36 |
| oil 32-34 (Dislab) | | | |
| NUTRALYS ® S85F | | | 0.87 |
| batch WB67J | | | |
| Pea protein isolate No. | | 0.87 | |
| 2 according to the | | | |
| invention | | | |
| Sodium caseinate EM7 | 1.75 | 0.88 | 0.88 |
| (DMV) | | | |
| Joha@ | 1.46 | 1.46 | 1.46 |
| KM2_E339_E452_E331 | | | |
| Dimodan HP_E471 | 0.58 | 0.58 | 0.58 |
| (Danisco) | | | |
| Water | 27.00 | 27.00 | 27.00 |
| TOTAL | 100.00 | 100.00 | 100.00 |

The amounts being indicated as weight percentages.

The nutritional values per 100 g are as follows.

| | Recipe No. | |
|---|---|---|
| | Recipe 1 | Recipes 2 and 3 |
| Moisture content (%) | 40 | 40 |
| Calorific energy (kCal) per 100 g | 369 | 369 |
| Fat | 24.0 | 24.0 |
| (g) | | |
| Protein content | 1.6 | 1.5 |
| (g) | | |
| Of which milk protein | 1.6 | 0.8 |
| Pea protein isolate | 0 | 0.7 |
| Carbohydrates | 33.0 | 33.0 |
| (g) | | |
| Of which sugars | 5.3 | 5.3 |

The manufacturing process is as follows:
Melt the fat at 80° with constant stirring,
Dissolve the monoglycerides and diglycerides in the liquid oil,
Dissolve the powdered protein in water at 50° C. over 30 minutes,
Add the glucose syrup and the phosphate salts already dissolved in part of the water,
Pre-emulsify the melted fat in the aqueous solution by stirring at 10 000 rpm,
Pasteurize at 80° C. for a few seconds,
Place the product at 75° C. in a Niro Panda 2K Soavi (GEA) high-pressure homogenizer at a pressure of 160 bar in the first stage, and bar in the second stage,
Dilute the mixture to 50% solids to atomize at 180° C. (Tᵢₙₗₑₜ) and 90° C. (Tₒᵤₜₗₑₜ) in the device with an evaporation capacity of 10 to 12 l/h.

The analyses performed on the formulation are as follows:

1) pH of the Emulsion

| pH | Recipe 1 | Recipe 2 | Recipe 3 |
|---|---|---|---|
| On the emulsion | 7.69 | 9.24 | 8.72 |
| at 25° C. | | | |
| On coffee at 75° C. | 6.45 | 6.35 | 6.10 |

2) Capacity of the Emulsion

Measurement of the size of the lipid globules (with a laser particle size analyzer) makes it possible to determine the capacity of the pea protein isolates according to the invention to form lipid globules of the smallest possible size.

| | Dx (10) | Dx (50) | Dx (90) | D [4.3] | |
|---|---|---|---|---|---|
| | (μm) | (μm) | (μm) | (μm) | Mode (μm) |
| Recipe 1 | 0.281 | 0.577 | 1.23 | 0.681 | 0.551 |
| Recipe 2 | 0.289 | 0.563 | 1.10 | 0.668 | 0.559 |
| Recipe 3 | 0.279 | 0.564 | 1.23 | 1.15 | 0.534 |

These results clearly show that the 50/50 mixture has a particle size distribution similar to the 100% caseinate control.

3) Viscosity of the Emulsions Containing 60% Solids at 65° C. (Before Atomization)

Apparatus:
Physica MCR 301 Anton Paar rheometer
Geometry: CC27
Method 0 to 1000 s⁻¹ in 660 s

Viscosity (mPa · s)

| | 5 s⁻¹ | 10 s⁻¹ | 40 s⁻¹ | 100 s⁻¹ |
|---|---|---|---|---|
| Recipe 1 | 89 | 69 | 47 | 44 |
| Recipe 2 | 49 | 48 | 43 | 39 |
| Recipe 3 | 170 | 132 | 89 | 77 |

The lowest viscosity of the 50/50 mixture makes it possible to atomize at a solids content higher than that conventionally required for caseinates.

4) Stabilization of Powdered “Non-Dairy Coffee Creamer” in Coffee

Reconstitution of Coffee:
a. Weigh out 2 g of soluble coffee
b. Add 8 g of emulsion and 150 ml of drinking water (calcium content of 136 mg and magnesium content of 60 mg) at 80° C.

The stability of the emulsion in coffee is determined by measuring the color variation of the preparation—color measurement according to the L (white balance), a (yellow balance) and b (green balance) coordinates, the white color in coffee being one of the key criteria sought by manufacturers and consumers.

A difference of 2 points for the measurement of the L parameter of the coffees prepared with the 50/50 mixture (L=+96) with regard to the control coffees prepared with caseinates (L=+98) reflects the excellent stability of the mixture with the pea protein isolates in accordance with the invention.

### Example 7. Use of the Pea Protein Isolates for the Preparation of Stirred Yoghurts

The object here is to replace 30% of the milk protein.

The recipes developed are as follows:

| | | | Recipe with | |
|---|---|---|---|---|
| | | | pea protein | |
| | | | isolate | |
| | | | No. 1 in | |
| | | Recipe | accordance | Recipe |
| | | with pea | with the | with pea |
| | Control | protein | invention | protein |
| In % | recipe | Recipe 1 | Recipe 2 | Recipe 3 |
| Reconstituted skimmed | 88.80 | 74.50 | 74.50 | 74.50 |
| milk | | | | |
| Cream (Les fayes 35% | 2.75 | 2.42 | 2.42 | 2.42 |
| fat) | | | | |
| Sugar | 6.00 | 6.00 | 6.00 | 6.00 |
| Modified starch | 1.50 | 3.20 | 3.20 | 3.20 |
| CLEARAM ® CR 4015 | | | | |
| from Roquette Freres | | | | |
| NUTRALYS ® S85F | | 1.40 | | |
| NUTRALYS ® F85F | | | | 1.40 |
| Pea protein isolate No. | | | 1.40 | |
| 1 according to the | | | | |
| invention | | | | |
| PROMILK 852 A | 0.77 | | | |
| Ingredia | | | | |
| Pectin CM 020 | 0.18 | 0.16 | 0.16 | 0.16 |
| HERBSTREITH & FOX | | | | |
| Water | | 12.32 | 12.32 | 12.32 |
| Total | 100.00 | 100.00 | 100.00 | 100 |

The amounts being indicated as weight percentages.

| | | | | |
|---|---|---|---|---|
| Solids | 17.73 | 18.28 | 18.31 | 18.28 |
| Total protein | 3.70 | 3.70 | 3.70 | 3.70 |
| Dairy protein | 3.70 | 2.58 | 2.58 | 2.58 |
| Plant protein | 0.00 | 1.12 | 1.12 | 1.12 |
| Lipids | 1.01 | 1.01 | 1.01 | 1.01 |
| Carbohydrates | 12.30 | 12.99 | 12.99 | 12.99 |
| of which sugars | 10.98 | 10.14 | 10.14 | 10.14 |
| Kcal/100 g | 73.10 | 75.84 | 75.86 | 75.84 |
| Degree of substitution | 0.00 | 30.19 | 30.19 | 30.19 |

The manufacturing process is as follows:
heat water to 60° C.,
add the proteins and leave to hydrate for 1 hour,
add the cream while mixing with a POLYTRON homogenizer for 2 minutes,
add the sugar/starch mixture over 10 to 15 minutes,
homogenize at high pressure (two stages: 1^{st} stage 180 bar—2^{nd} stage 200 bar) at 75-80° C.,
pasteurize with a Power Point International tubular exchanger at 95° C., 6 minutes—20 l/h,
add the ferments (YoFlex® YF-L812—50 U/250 L),
acidify at 42° C. to pH 4.6 (acidification time of 5-6 hours),
stir at 3600 rpm and at 42° C.,
smooth at 37/38° C. at 3600 rpm with a Spindle 2G
place in a pot and store at 4° C.

Viscosity Measurement

| | Measurement |
|---|---|
| | temperature: 13° C. |
| Rheometer: | Physioa MCR 301 Anton |
| | Pear |
| Geometry: | CC27 |
| Method: | 0 to 350 s⁻¹ in 180 s and |
| | return from 350 s⁻¹ to 0 |
| | in 180 s |

The values are given to within ±5%.

| | | | | | | Hysteresis |
|---|---|---|---|---|---|---|
| | Viscosity (Pa · s) | | | | | area |
| Reference | 5 s⁻¹ | 10 s⁻¹ | 40 s⁻¹ | 100 s⁻¹ | 350 s⁻¹ | (Pa) |
| | D + 3 | | | | | |
| Recipe 2 | 4.3 | 2.6 | 1.03 | 0.53 | 0.2 | 4130 |
| Recipe 1 | 3.9 | 2.38 | 0.98 | 0.52 | 0.21 | 3335 |
| Recipe 3 | 3.76 | 2.3 | 0.97 | 0.53 | 0.22 | 2610 |
| Control recipe | 3.12 | 2.1 | 0.79 | 0.4 | 0.15 | 2420 |
| | D + 7 | | | | | |
| Recipe 2 | 4.12 | 2.49 | 1.02 | 0.535 | 0.212 | 3710 |
| Recipe 1 | 3.26 | 2.21 | 0.84 | 0.41 | 0.16 | 2551 |
| Recipe 3 | 3.71 | 2.29 | 0.96 | 0.52 | 0.21 | 2905 |
| Control recipe | 4.17 | 2.51 | 1.02 | 0.53 | 0.2 | 4200 |
| | D + 14 | | | | | |
| Recipe 2 | 3.93 | 2.38 | 0.99 | 0.524 | 0.21 | 3260 |
| Recipe 1 | 3.54 | 2.17 | 0.94 | 0.52 | 0.22 | 2420 |
| Recipe 3 | 4.13 | 2.51 | 1.02 | 0.51 | 0.19 | 4860 |
| Control recipe | 2.74 | 1.82 | 0.7 | 0.35 | 0.138 | 2200 |

Recipe 3 has the closest behavior to the control recipe but with, however, inversion of the viscosity curve relative to the change in viscosity of the control recipe at D+7 and D+14.

Specifically, recipe 3 regains in viscosity at D+14, and is the most resistant to shear at D+14.

Recipe 1 is more viscous and resistant to shear than recipe 3 at D+7, but this reverses from D+14.

Recipe 2 with the pea protein isolate in accordance with the invention is the most viscous of the four recipes, and is more viscous than the control recipe. Its viscosity decreases over time.

These results demonstrate that, by virtue of its behavior, the pea protein isolate in accordance with the invention would make it possible to decrease the amount of starch in this recipe if it is desired to make it resemble the viscosity of the control recipe.

The same goes, but to a lesser extent, for recipes 1 and 3.

### Example 8: Comparison of the Sensory Properties of Stirred Yoghurts

For the taste evaluation, the panel consisted of 11 people. For the texture evaluation, the panel consisted of 12 people.

The panels are qualified for tasting products formulated with pea protein. They received training so as to check their performance in terms of:
Capacity to discriminate the products
Consensus, correct use of the descriptors
Repeatability, ability to detect a product submitted twice

Specifically, they received training in the correct use of the sensory descriptors of taste and texture, for instance:

Taste Descriptors:

| | | | | taste/ |
|---|---|---|---|---|
| flavor/odor | | | | mouthfeel |
| milky | vegetable | flavor | off flavor | |
| milk | pea/vegetable | vanilla | paper/cardboard | acidic |
| | AG | | | |
| whey | cereals | caramel | detergent | bitter |
| fermented milk | vegetable | | chemical | salty |
| reconstituted | fresh walnut | | glue | astringent/ |
| baby milk | | | | drying |
| yoghurt | potato | | metallic | sweet |
| butter | | | | spicy |

Texture Descriptors

| | | | |
|---|---|---|---|
| Descriptor | Definition | Procedure | Reference |

Appearance

| | | | |
|---|---|---|---|
| Glossy | Glossy or lustrous | Explore the product visually. | Raw egg yolk |
| | appearance resulting | | |
| | from the tendency of a | | |
| | surface to reflect light. | | |
| | (not glossy/very glossy) | | |
| Granular | Evaluation of the granular | Explore the product visually. | Brown sugar |
| | nature and of the number | | |
| | and size of particles of a | | |
| | product. | | |
| | (not granular/very | | |
| | granular) | | |

Texture on a spoon

| | | | |
|---|---|---|---|
| Gelled | Evaluation of the | Explore the product visually. | Gelatin |
| | consistency of the | | |
| | product. | | |
| | (not gelled/very gelled) | | |
| Thick | Evaluation of the ease of | Take up a product unit with a | Honey |
| | the product to flow under | spoon. Raise and turn the | |
| | a mechanical action. | spoon over. Check the | |
| | (not thick/very thick) | flowability. | |
| Runny | Evaluation of the capacity | Apply the spoon | Water |
| | to trickle without dividing | perpendicular to the surface, | |
| | into drops. | place under pressure and | |
| | (not runny/very runny) | gently withdraw it vertically. | |
| Coating | Evaluation of the capacity | Apply the spoon | Custard |
| | to form a coat on the back | perpendicular to the surface | |
| | of the spoon. | and gently withdraw it | |
| | (not coating/very coating) | vertically. | |

Mouthfeel

| | | | |
|---|---|---|---|
| Aqueous | Evaluation of the texture | Taste a product unit and | Watermelon |
| | property of the surface | evaluate the amount of water | |
| | qualifying the perception | perceived in the mouth. | |
| | of the amount of water | | |
| | released by a product. | | |
| | (not aqueous/very | | |
| | aqueous) | | |
| Drying | Evaluation of the texture | Chew a product unit and | Cranberry juice |
| | property describing the | check whether the inside of | |
| | perception of the | the mouth becomes dry. | |
| | absorption of moisture by | | |
| | the product. | | |
| | (not drying/very drying) | | |
| Greasy | Evaluation of the greasy | After swallowing a product | Olive oil |
| | film after swallowing. | unit, evaluate the presence or | |
| | (not greasy/very greasy) | absence of a greasy film on | |
| | | the palate or teeth by | |
| | | sweeping over their surface | |
| | | with the tongue. | |
| Creamy | Evaluation of the soft and | Chew a product unit and | Creme fraîche, |
| | fondant texture of the | check whether it causes a soft | double cream |
| | product. | contact and whether it lines | |
| | (not creamy/very creamy) | the mouth. | |
| Thick | Evaluation of the ease of | Rub the tongue against the | Sweet and |
| | the product to flow in the | palate and check whether the | concentrated |
| | mouth. | product flows easily. | milk, honey |
| | (not thick/very thick) | | |
| Tacky | Evaluation of the force | After chewing a few times | Soft caramel |
| | required to detach | successively, press the | |
| | products that adhere to | product between the teeth | |
| | the inside of the oral | and measure the force | |
| | cavity. | required for it to be detached | |
| | (not tacky/very tacky) | from the teeth. | |
| Granular | Evaluation of the granular | Rub the tongue against the | Brown sugar |
| | nature and of the number | palate and check whether the | |
| | and size of particles of a | product contains particles. | |
| | product. | | |
| | (not granular/very | | |
| | granular) | | |

Products

The three products tested of example 11 (control recipe, recipe 1 and recipe 2) were evaluated three days after being produced and were presented at a temperature of about 10° C. (products stored in a refrigerator, evaluated when taken out).

Tasting Conditions
In a sensory analysis laboratory: individual tasting cubicles, white walls, calm environment (to facilitate concentration)
White light (to have exactly the same vision of the product)
At the end of the morning or the afternoon (to be at the height of the sensory capacities)
Products rendered anonymous with a three-figure code (to prevent the code from influencing the assessment of the products)
Products presented in a random order (to prevent order and persistence effects)

Exercise

The method employed to compare the products was the Flash Profile (J. M. Sieffermann, 2000).

The products are all presented simultaneously. It is a matter of comparing the products by making a succession of classifications: the panelists choose the descriptors which appear to them to be the most pertinent to discriminate between the products, and classify the products according to these descriptors; it is possible that several products are grouped in the same row.

### Example

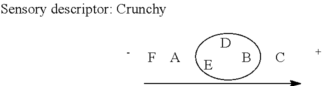

Two lists of descriptors, relating to the taste or to the texture, were proposed to the panelists as a guide: they are attached in the appendix of this report.

Data Processing

The statistical processing method suited to this type of data is multiple factor analysis (J. Pagès, 1994) on the data-rows of the products. In order for the results to be clearer, the MFA was performed several times; globally, and per criterion (aspect, odor, taste, texture). The graphs presented summarize all of the results provided by this method.

The statistical processing was performed with the software R version 2.14.1 (2011 Dec. 22).

Results:

The results are presented in FIGS. 12 (taste) and 13 (texture):
The stirred yoghurt containing NUTRALYS® S85F has a runny and granular texture in the mouth accompanied by a pea, cardboard, fresh walnut taste;
The yoghurt with milk protein appears more fatty and creamy, thick with a granular aspect, its taste is more typical of yoghurt, sweet and milky;
The yoghurt with the pea protein isolate No. 1 in accordance with the invention lies between the control and the tests with NUTRALYS® S85F, and stands out by having a cereal and fermented milk taste and also a particularly coating texture in the mouth.

### Example 9. Mozzarella-Type Vegan Cheeses Containing Pea Protein Isolates

The vegan cheese recipe containing pea protein isolates No. 2 according to the invention is given in the following table.

The control is a recipe containing pea protein of NUTRALYS F85F type.

Recipe

| | | No. 2 |
|---|---|---|
| | | Pea protein |
| | No. 1 | isolate No. 2 |
| | NUTRALYS | according to the |
| | F85F | invention |
| Rapeseed oil | 7.98 | 7.98 |
| Coconut oil | 14.82 | 14.82 |
| Acetylated potato starch | 22.9 | 22.9 |
| CLEARAM PG 9020 from | | |
| Roquette Freres | | |
| pea protein or pea protein | 5 | 5 |
| isolate | | |
| Citric acid | 0.3 | 0.3 |
| Salt | 1.7 | 1.7 |
| Inactivated yeasts | 1.1 | 1.1 |
| Water | 41.7 | 41.9 |
| Cheese flavoring | 0.25 | 0.25 |
| Cassava starch | 4 | 4 |
| OSI Pea masker 9767A | 0.25 | 0.25 |
| Total | 100 | 100 |

The amounts being given as weight percentages.

The process for preparing the recipe is as follows:
add the water to a container equipped with a heating jacket (such as a Stephan Bowl—www.stephan-machinery.com/index.php?id=3) and heat to 50° C.,
add all the powder ingredients, except for the citric acid,
mix at 750 rpm for 2 minutes at 50° C.,
add the oils and mix for 2 minutes at 750 rpm,
add the citric acid and mix for 1 minute at 750 rpm,
heat the mixture to 75° C. while mixing regularly by hand so as to prevent it from browning,
stop the entry of steam into the jacket,
cook for 5 minutes, while mixing regularly,
stop the cooking and store at +6° C.

Analyses of color, texture, “shreddability” (capacity to be shredded), and stability to freezing/thawing and melting were undertaken.

While the color and texture of the two recipes are equivalent, the recipe with the pea protein isolate No. 2 has better “shreddability” behavior (capacity to be shredded) and better stability on melting. The taste is moreover acknowledged as being better with recipe No. 2.

### Example 10. Total Substitution of Milk Protein with the Pea Protein Isolates in Vanilla-Flavored Dessert Creams

The object here is to replace 100% of the milk protein by preparing vanilla-flavored creams.

The recipes produced are the following:

| Ingredients | Recipe 1 | Recipe 2 |
|---|---|---|
| Maltodextrin GLUCIDEX ® IT 19 from | 4 | 4 |
| ROQUETTE FRERES | | |
| Sunflower oil | 2 | 2 |
| Glucose syrup | 19.17 | 19.17 |
| NUTRALYS ® S85F | 3 | |
| Pea protein isolate No. 2 according the invention | | 3 |
| Corn starch, standard (ROQUETTE FRERES) | 0.500 | 0.500 |
| Modified corn starch CLEARAM ® CR3020 | 3.250 | 3.250 |
| (ROQUETTE FRERES) | | |
| Tribasic calcium phosphate Cal-Sistent (28280) | 0.280 | 0.280 |
| Salt | 0.030 | 0.030 |
| Vanilla extract (MANE M0055240) | 0.35 | 0.35 |
| Water | 67.225 | 67.225 |
| Liquid colorant (NBC YELLOW C220 WSS) | 0.06 | 0.66 |
| Total | 100 | 100 |

The amounts being given as weight percentages.

The nutritional values per 100 g are as follows:

| | | |
|---|---|---|
| Calorific energy (kcal) | 134 | 134 |
| Fat (g) | 2.3 | 2.3 |
| Carbohydrates (g) | 26.1 | 26.1 |
| Protein (g) | 2.4 | 2.4 |
| Salt (g) | 0.14 | 0.17 |
| Calcium (mg) | 130 | 128 |

The process for manufacturing the dessert creams is as follows:
hydrate the protein in water at 55° C. for 30 minutes with a Silverson mixer (3500 rpm);
add the syrup and the calcium, wait for 5 minutes and then add the other powders;
add the colorant;
add the sunflower oil at the maximum speed (10 000 rpm) with a Silverson mixer over 5 minutes;
place the product in a high-pressure homogenizer at 100 bar at 57° C.;
sterilize at 135° C. for 55 seconds at 20 liters/hour;
cool to about 75° C.;
store at 4° C.

Sensory Analysis

The panel consisted of 12 people.

The panel, as in the preceding examples, is qualified for tasting products formulated with pea protein. It received training so as to check its performance in terms of:
Capacity to discriminate the products
Consensus, correct use of the descriptors
Repeatability, ability to detect a product submitted twice.

Tasting conditions: in the sensory analysis laboratory: individual tasting cubicles, white walls, calm environment (to facilitate concentration), white light (to have the same vision of the product), at the end of the morning, between 10:00 and 12:00 (to be at the height of the sensory capacities). The products are rendered anonymous with a three-figure code and presented in a random order (to avoid order and persistence effects) so as to avoid any saturation effect. The judges commenced randomly with either of the two tests. The products were evaluated at D+8 days at 4° C. on removal from the refrigerator.

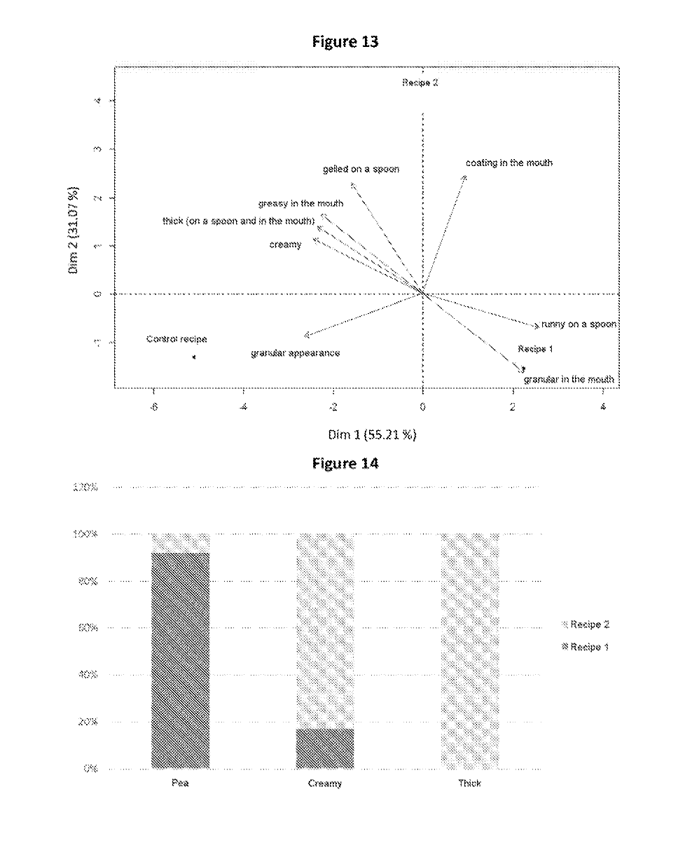

The sensory analysis results are presented in FIG. 14. The judges found that the dessert cream prepared with the pea protein isolate according to the invention had much less pea taste and was thicker and creamier than that prepared with the pea protein NUTRALYS® S85F.

Viscosity Measurement

The viscosity of the dessert creams according to the two recipes was measured. The characterization was made on D+3 and D+7.

| | Measurement temperature: 13° C. |
|---|---|
| Rheometer: | Physica MCR 301 Anton Paar |
| Geometry: | CC27 |
| Method: | 0 to 350 s⁻¹ in 180 s and return from 350 s⁻¹ to 0 in 180 s |

| | | | | | | Hysteresis |
|---|---|---|---|---|---|---|
| | Viscosity (Pa · s) | | | | | area |
| | 5 s⁻¹ | 10 s⁻¹ | 40 s⁻¹ | 100 s⁻¹ | 350 s⁻¹ | (Pa) |
| Recipe 1 | 4.88 | 2.94 | 1.29 | 0.71 | 0.35 | 1559 |
| D + 3 | | | | | | |
| Recipe 1 | 3.79 | 2.31 | 1.05 | 0.59 | 0.30 | 961 |
| D + 7 | | | | | | |
| Recipe 2 | 5.70 | 3.42 | 1.43 | 0.84 | 0.42 | 2897 |
| D + 3 | | | | | | |
| Recipe 2 | 8.50 | 5.01 | 2.08 | 1.27 | 0.64 | 4919 |
| D + 7 | | | | | | |

The recipe with NUTRALYS® S85F has a lower viscosity level than the recipe prepared with the pea protein isolate according to the present invention.

1. A nutritional formulation selected from a fermented milk of yoghurt type, a cream, a dessert cream, an iced dessert or sorbet and a cheese and containing a pea protein isolate, wherein the pea protein isolate:
contains between 0.5 and 2% of free amino acids,
has a viscosity at 20° C.:
from 11 to 18×10⁻³ Pa·s. at a shear rate of 10 s⁻¹,
from 9 to 16×10⁻³ Pa·s. at a shear rate of 40 s⁻¹, and
from 8 to 16×10⁻³ Pa·s. at a shear rate of 600 s⁻¹,
has a solubility:
from 30 to 40% in pH zones from 4 to 5
from 40 to 70% in pH zones from 6 to 8.

2. The formulation as claimed in claim 1, wherein the pea protein isolate has a digestibility expressed according to the Coefficient of Digestive Use (CDU) of between 93.5 and 95%.

3. The formulation as claimed in claim 1, wherein the pea protein isolate has a degree of hydrolysis (DH) of between 5 and 10%.

4. The formulation as claimed in claim 1, wherein the pea protein isolate is presented, according to the SYMPHID test, as a protein of “rapid viscosity”, reflecting rapid duodenal assimilation of the constituent amino acids of said isolate.

5. The formulation as claimed in claim 1, in which the pea protein isolate has been pasteurized at high temperature for a short time before being dried by atomization.

6. The formulation as claimed claim 1, in which the pea protein isolate represents 0.1-10% by weight of the nutritional formulation, preferably from 0.5-6% by weight.

7. The formulation as claimed claim 1, in which the pea protein isolate represents 20-30%, 40-50%, 50-60%, 60-70%, 70-80%, 80-90% or 90-100% by weight of the total protein in the nutritional formulation.

8. The formulation as claimed in claim 1, also comprising at least one milk protein.

9. The nutritional formulation as claimed in claim 8, in which the formulation is in powder form and comprises at least one pea protein isolate and at least one milk protein, in which the milk protein represents at least 10% by weight relative to the total weight of protein.

10. The formulation as claimed in claim 1, in which the pea protein isolate represents:
between 0.1% and 100% of the total protein for the fermented milks of yoghurt type,
between 0.1% and 100% of the total protein for the dairy creams, iced desserts or sorbets,
between 50 and 100% of the total protein for the coffee whiteners.

11. (canceled)
